(19) United States
(12) Patent Application Publication
(10) Pub. No.: US 2011/0205734 A1
(43) Pub. Date: Aug. 25, 2011

(54) OPTICAL SHEET STACK BODY, ILLUMINATING DEVICE, AND DISPLAY DEVICE

(75) Inventors: Shigehiro Yamakita, Miyagi (JP); Shogo Shinkai, Miyagi (JP); Yasuyuki Kudo, Miyagi (JP); Taku Ishimori, Miyagi (JP); Eiji Ohta, Miyagi (JP); Yutaka Muramoto, Miyagi (JP)

(73) Assignee: SONY CORPORATION, Tokyo (JP)

(21) Appl. No.: 13/029,364

(22) Filed: Feb. 17, 2011

(30) Foreign Application Priority Data
Feb. 24, 2010 (JP) P2010-039269

(51) Int. Cl. F21V 11/16

(52) U.S. Cl. 362/235

(57) ABSTRACT

An optical sheet stack body includes two optical sheets disposed to overlap a plurality of point light sources arranged in a first direction and arranged in a second direction crossing the first direction. The optical sheets are disposed so that a long-side direction of the optical sheet crosses the first and second directions at an angle other than right angle. A first optical sheet disposed on the point light source side has a plurality of first three-dimensional structures extending in a direction parallel to or almost parallel to the first direction. A second optical sheet disposed on the side opposite to the point light source has a plurality of second three-dimensional structures extending in a direction parallel to or almost parallel to the second direction. The second three-dimensional structure has a shape by which return light is generated from normal incident light more than the first three-dimensional structure.

### CROSS REFERENCES TO RELATED APPLICATIONS

The present application claims priority to Japanese Priority Patent Application JP 2010-039269 filed in the Japanese Patent Office on Feb. 24, 2010, the entire content of which is hereby incorporated by reference.

### BACKGROUND

The present invention relates to an optical sheet stack body suitably applied to an illuminating device or the like for illuminating, for example, a transmissive liquid crystal panel from the back side, and an illuminating device and a display device each having the same.

In recent years, because of advantages such as lower power consumption and smaller space, reduction in price, and the like, a liquid crystal display is replacing a CRT (Cathode Ray Tube) which was the mainstream of a display device in the past.

There are some types of liquid crystal displays which are classified by illuminating methods employed at the time of, for example, displaying an image, and a typified one is a transmissive liquid crystal display for displaying an image by using a light source disposed on the back of a liquid crystal panel.

In such a display device, it is desired to widen a color reproduction range. As one of methods of widening a color reproduction range, it is proposed to use, as a light source, light emitting diodes (LED) of three primary colors of blue, green, and red in place of a cold cathode fluorescent lamp (CCFL). It is also proposed to use LEDs of not only three primary colors but also four primary colors or six primary colors in order to widen the color range. Further, it is proposed to use, as a light source of white light, a light emitting diode of blue to which a phosphor is applied. Concretely, a light emitting diode of blue to which a phosphor of yellow is applied and a light emitting diode of blue to which phosphors of green and red are applied are on the market. In the following, in the specification, an LED which contains such a phosphor and emits white light will be called a white LED.

In the case of using a CCFL or LED as a light source, it is necessary to uniformize the luminance distribution and the color distribution in the plane. In the case where an illuminating device is relatively small, a light guide plate of a side light type may be used. In the case where an illuminating device is relatively large and a large light amount is necessary, a direct type in which light sources are directly arranged is in the mainstream. As one of methods of suppressing luminance non-uniformity and color unevenness in a direct type, a method of disposing a diffuser plate in which filler is added on a light source is proposed (Japanese Unexamined Patent Application Publication No. Sho 54-155244). As another method, for example, a method of using a plate whose sectional shape is uniform in one direction is proposed (Japanese Unexamined Patent Application Publication No. 2005-326819).

For example, in addition to an LED 100 as illustrated in FIG. 18A, a wide-directivity-angle LED 200 in which a light distribution is changed by providing a cap 110 made of a specific transparent resin on the LED 100 as illustrated in FIG. 18B is also proposed. FIG. 19 illustrates an example of the light distribution of the wide-directivity-angle LED 200 with the cap and that of the LED 100 without a cap. LED1 and LED2 in FIG. 19 indicate light distributions of the wide-directivity-angle LED 200 with the cap, and BARE in FIG. 19 indicates the light distribution of the LED 100 without a cap. It is understood from FIG. 19 that, in the wide-directivity-angle LED 200, the amount of light emitted to the front direction is suppressed, and the amount of light emitted obliquely increases. That is, the wide-directivity-angle LED 200 has the maximum value of light intensity not in the front direction but in the oblique directions. Therefore, in the case of applying the wide-directivity-angle LED 200 to an illuminating device, luminance non-uniformity in the plane is suppressed to a certain degree. The light distribution of the wide-directivity-angle LED 200 is changed according to the shape and refractive index of the cap 110.

### SUMMARY

In the case of using an LED of three primary colors or a white LED as the light source of an illuminating device, as compared with the case of using a CCFL as the light source of the illuminating device, it is difficult to suppress luminance non-uniformity and color unevenness in the plane. It is caused by the facts that the LED is a point light source and, particularly, in the case of an LED of three primary colors, white color has to be generated by mixing the three colors whereas the CCFL emits white light. For example, in the case of Japanese Unexamined Patent Application Publication No. Sho 54-155244, particularly, when an LED is used as the light source, the distance from the light source to a diffuser plate has to be set relatively long, and there is a shortcoming such that the illuminating device becomes thick. On the other hand, in the case of Japanese Unexamined Patent Application Publication No. 2005-326819, although the CCFL as a linear light source is valid, an LED as a point light source has a shortcoming such that luminance non-uniformity and color unevenness occurs. The method of using the wide-directivity-angle LED 200 also has shortcomings such that by providing each of the LEDs 100 with the cap 110, the number of processes increases and, even when the shape and the refractive index of the cap 110 are optimized, there is limitation in shortening of the distance from the light source to the diffuser plate, and the illuminating device becomes thick to a certain degree.

It is therefore desirable to provide an optical sheet stack body in which luminance non-uniformity and color unevenness caused by a point light source are reduced, and an illuminating device and a display device each having the optical sheet stack body.

An optical sheet stack body according to an embodiment of the invention includes two rectangular-shaped optical sheets disposed so as to overlap a plurality of point light sources arranged in a first direction and arranged in a second direction crossing the first direction. Each of the optical sheets is disposed so that a long-side direction of the optical sheet crosses each of the first and second directions at an angle other than right angle. A first optical sheet as an optical sheet disposed on the point light source side out of the two optical sheets has a plurality of first three-dimensional structures extending in a direction parallel to or almost parallel to the first direction. On the other hand, a second optical sheet as an optical sheet disposed on the side opposite to the point light source out of the two optical sheets has a plurality of second three-dimensional structures extending in a direction parallel to or almost parallel to the second direction. The second three-dimensional structure has a shape by which return light is generated from normal incident light more than the first three-dimensional structure.

An illuminating device according to an embodiment of the invention includes: a plurality of point light sources arranged in a first direction and arranged in a second direction crossing the first direction; and an optical sheet stack body including two rectangular-shaped optical sheets disposed so as to overlap the plurality of point light sources. The two optical sheets included in the illuminating device as an embodiment of the invention have the same components as those of the two optical sheets included in the above-mentioned optical sheet stack body.

A display device according to an embodiment of the invention includes: a display panel which is driven on the basis of an image signal; and an illuminating device which illuminates the display panel. The illuminating device included in the display device as an embodiment of the invention has the same components as those of the above-mentioned illuminating device.

In the optical sheet stack body, the illuminating device, and the display device of an embodiment of the present invention, the first optical sheet formed with a plurality of first three-dimensional structures extending in parallel to or almost parallel to one arrangement direction of the point light source, and the second optical sheet formed with a plurality of second three-dimensional structures extending in a direction parallel to or almost parallel to the other arrangement direction of the point light source are overlapped from the point light source side. Further, the second three-dimensional structure has a shape by which return light is generated from normal incident light more than the first three-dimensional structure. Consequently, the ratio of light which enters normal to the second optical sheet in light refracted and passed through the first three-dimensional structure, is reflected by the second three-dimensional structure, and becomes return light traveling to the point light source side increases.

In the optical sheet stack body, the illuminating device, and the display device of an embodiment of the present invention, the second three-dimensional structure has a shape by which return light is generated from normal incident light more than the first three-dimensional structure. Consequently, the ratio of light which enters normal to the second optical sheet in light refracted and passed through the first three-dimensional structure, is reflected by the second three-dimensional structure, and becomes return light traveling to the point light source side increases. Since a light source division image formed by the first three-dimensional structure is cancelled by the second three-dimensional structure, luminance non-uniformity and color unevenness caused by the point light sources is reduced.

Additional features and advantages are described herein, and will be apparent from the following Detailed Description and the figures.

### BRIEF DESCRIPTION OF THE FIGURES

FIG. 1 is a cross section illustrating a configuration of an illuminating device according to an embodiment of the present invention.

FIG. 2 is an expanded perspective view illustrating an example of the illuminating device of FIG. 1.

FIG. 3 is an expanded perspective view illustrating a first modification of the illuminating device of FIG. 1.

FIG. 4 is an expanded perspective view illustrating a second modification of the illuminating device of FIG. 1.

FIG. 5 is a cross section of a projection in an unevenness canceling sheet in FIG. 1.

FIG. 6 is an expanded perspective view illustrating a third modification of the illuminating device in FIG. 1.

FIG. 7 is a cross section illustrating a fourth modification of the illuminating device in FIG. 1.

FIGS. 8A and 8B are a cross section and a perspective view illustrating joining of unevenness canceling sheets in FIG. 1.

FIGS. 9A to 9C are cross sections illustrating a fifth modification of the illuminating device in FIG. 1.

FIG. 10 is a cross section illustrating a sixth modification of the illuminating device in FIG. 1.

FIG. 11 is a correspondence diagram expressing the configuration of the illuminating device according to an example and measurement and determination results of luminance non-uniformity corresponding to the configuration.

FIG. 12 is a correspondence diagram expressing the configuration of the illuminating device according to the example and measurement and determination results of luminance non-uniformity corresponding to the configuration.

FIG. 13 is a correspondence diagram expressing the configuration of the illuminating device according to the example and measurement and determination results of luminance non-uniformity corresponding to the configuration.

FIG. 14 is a correspondence diagram expressing the configuration of the illuminating device according to the example and measurement and determination results of luminance non-uniformity corresponding to the configuration.

FIG. 15 is a correspondence diagram expressing the configuration of the illuminating device according to the example and measurement and determination results of luminance non-uniformity corresponding to the configuration.

FIG. 16 is a correspondence diagram expressing the configuration of the illuminating device according to the example and measurement and determination results of luminance non-uniformity corresponding to the configuration.

FIG. 17 is a correspondence diagram expressing the configuration of the illuminating device according to the example and measurement and determination results of luminance non-uniformity corresponding to the configuration.

FIGS. 18A and 18B are cross sections illustrating an example of a schematic configuration of a point light source in each of the examples.

FIG. 19 is a distribution diagram illustrating an example of light distributions of point light sources of FIGS. 18A and 18B.

FIG. 20 is a cross section illustrating sectional shapes of projections 11A and 12A in each of the examples.

FIG. 21 is a correspondence diagram illustrating various diffuser plates and total light transmittance of each of the diffuser plates.

FIG. 22 is a diagram illustrating total light transmittance of each of various fillers.

FIG. 23 is a correspondence diagram illustrating various diffuser plates, total light transmittance of each of the diffuser plates, and measurement and determination results of luminance and luminance non-uniformity.

FIG. 24 is a cross section illustrating an example of a display device according to an application example of the illuminating device in FIG. 1.

FIG. 25 is a cross section illustrating a modification of the display device of FIG. 24.

### DETAILED DESCRIPTION

Embodiments of the present application will be described below in detail with reference to the drawings.

1. Embodiment

Configuration

Operation and Effect

2. Modification

3. Example

Embodiment

Configuration

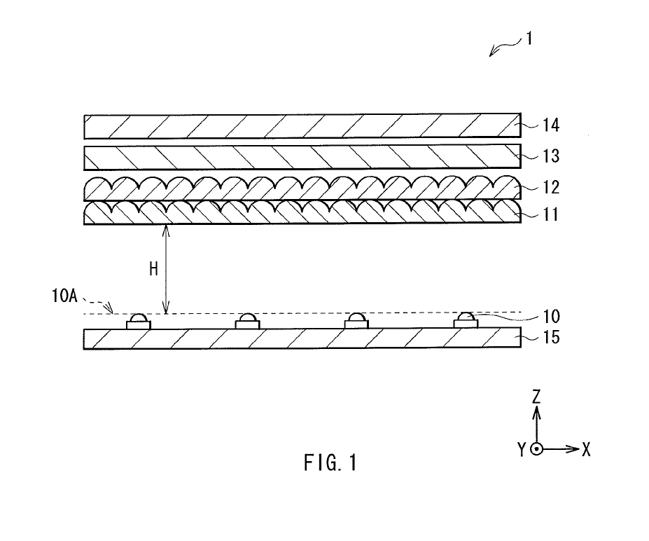

FIG. 1 illustrates a sectional configuration of an illuminating device 1 according to an embodiment of the present invention.

The illuminating device 1 has a plurality of point light sources 10 disposed in one plane 10A, unevenness canceling sheets 11 and 12 (optical sheets), a diffusing member 13, a prism sheet 14, and a reflection sheet 15. The reflection sheet 15 is disposed so as to be opposed to the plurality of point light sources 10 at the back of the point light sources 10. The unevenness canceling sheets 11 and 12, the diffusing member 13, and the prism sheet 14 are disposed in this order on the point light sources 10 side and on the side opposite to the reflection sheet 15 with respect to the point light sources 10, so as to be opposed to the plurality of point light sources 10. In the following, the point light source 10, the diffusing member 13, the prism sheet 14, and the reflection sheet 15 will be described and, after that, the unevenness canceling sheets 11 and 12 will be described.

Point Light Source 10

Each point light source 10 is, for example, an LED of one or more single color (the same color), a single LED which emits red (R), green (G), or blue (B), or a plurality of LEDs which separately emit light of three primary colors of R, G, and B.

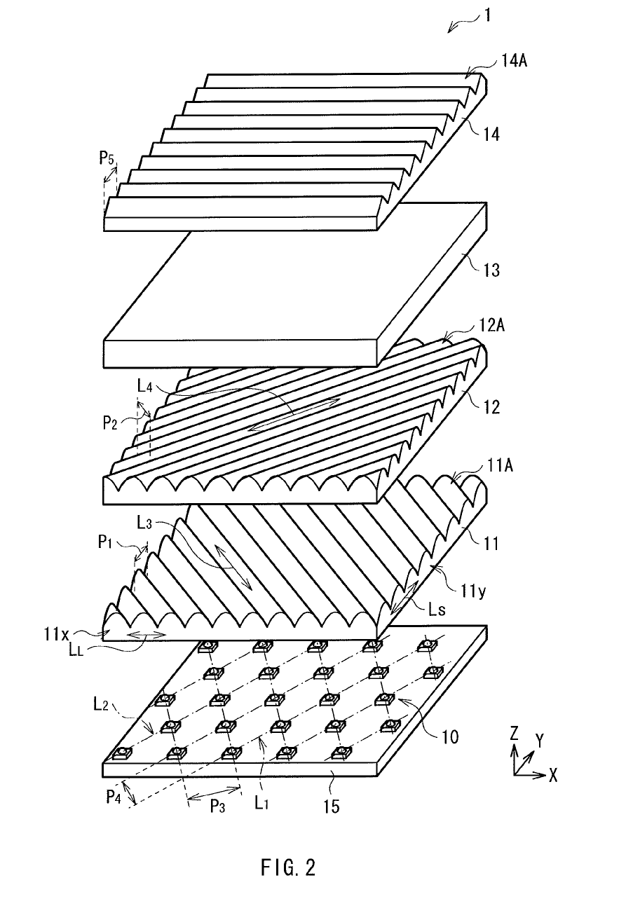

As illustrated in FIG. 2, the point light sources 10 are disposed in a direction (arrangement direction L₁) crossing both of a direction of a long side 11x (long-side direction L_{L}) of the rectangular-shaped unevenness canceling sheet 11 and a direction of a short side 11y (short-side direction L_{S}) at an angle other than the right angle. As illustrated in FIG. 2, the point light sources 10 are also disposed in a direction (arrangement direction L₂) crossing the arrangement direction L₁ and crossing both of the long-side direction L_{L} and the short-side direction L_{S} of the unevenness canceling sheet 11 at an angle other than the right angle. That is, the plurality of point light sources 10 are two-dimensionally disposed in a direction tilted only by a predetermined angle in an XY coordinate system using the long-side direction L_{L} of the unevenness canceling sheet 11 as the X axis and using the short-side direction L_{S} of the unevenness canceling sheet 11 as the Y axis.

The arrangement directions L₁ and L₂ of the point light sources 10 refer to two directions: a direction (for convenience, called direction L_{A}) of a line segment connecting, in shortest distance, a certain point light source 10 (hereinbelow, called “point light source A”) and a point light source 10 closest to the point light source A among the other plural point light sources 10 disposed around the point light source A (when there are a plurality of other point light sources 10 closest to the point light source A, one of them); and a direction (for convenience, called direction L_{B}) of a line segment connecting, in shortest distance, the point light source A and another point light source 10 closest to the point light source A, in the plurality of other point light sources 10 existing in a direction crossing the direction L_{A} when seen from the point light source A. Therefore, the direction L₁ corresponds to, for example, the direction L_{A}, and the direction L₂ corresponds to, for example, the direction L_{B}.

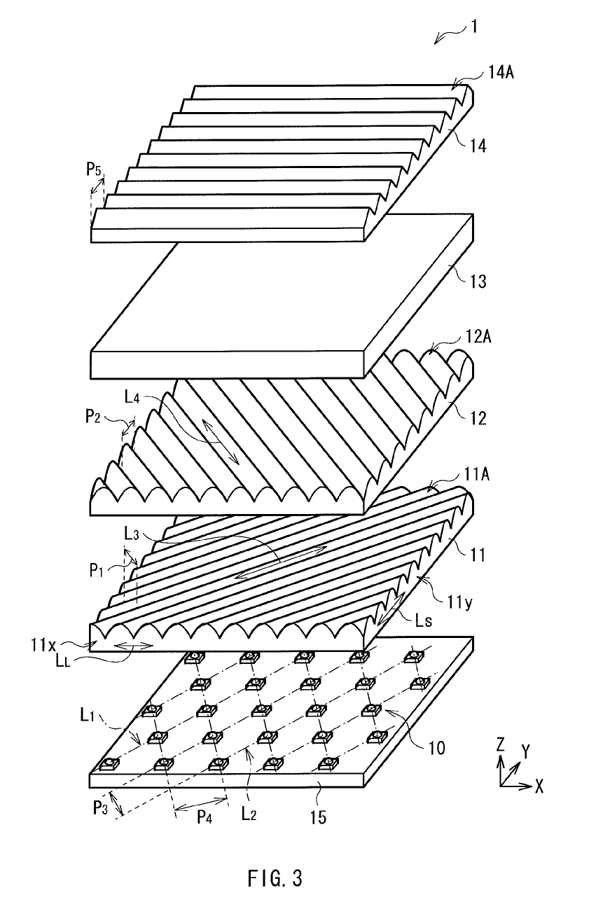

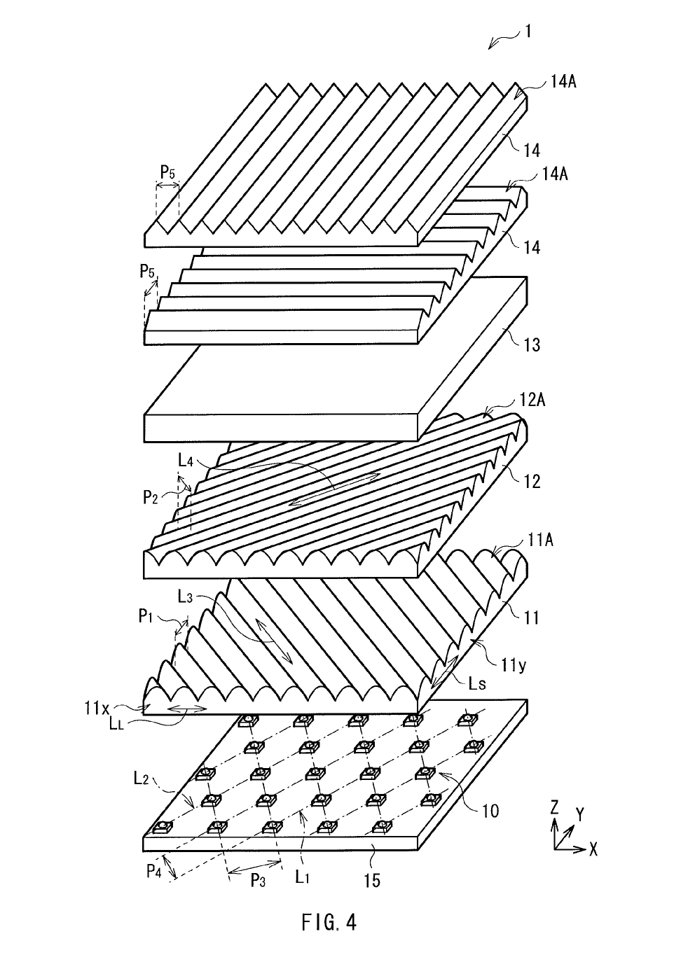

The arrangement directions L₁ and L₂ of the point light sources 10 are set according to extension directions L₃ and L₄ (which will be described later) of a three-dimensional structure of the unevenness canceling sheets 11 and 12. For example, as illustrated in FIG. 3, in the case where the ridge line direction of the unevenness canceling sheet 11 and that of the unevenness canceling sheet 12 are opposite to those in FIG. 2, the arrangement directions L₁ and L₂ of the point light sources 10 are also set opposite to those in FIG. 2. That is, in the embodiment, in any of the cases of FIGS. 2 and 3, the arrangement direction L₁ and the extension direction L₃ are parallel or almost parallel to each other, and the arrangement direction L₂ and the extension direction L₄ are parallel or almost parallel to each other.

As described above, the arrangement directions L₁ and L₂ of the point light sources 10 and the long-side direction L_{L} and the short-side direction L_{S} of the rectangular-shaped unevenness canceling sheet 11 form an angle other than the right angle. The angle is determined by the matrix of arrangement of the point light sources 10 and is not limited to a specific angle. From the viewpoint of preventing luminance non-uniformity, preferably, the point light sources 10 are disposed isotropically as much as possible. The angle formed between the arrangement direction L₁ and the long-side direction L_{L} is, preferably, in the range of 30 to 60 degrees both inclusive and, more preferably, in the range of 36 to 54 degrees both inclusive and, furthermore preferably, about 45 degrees.

The arrangement of the point light sources 10 varies slightly according to the size of the illuminating device 1 and a display device having the illuminating device 1. The arrangement of the point light sources 10 also varies according to the way of determining the number of blocks on the circuit of the point light source 10 at the time of giving the function of suppressing unnecessary light emission in a dark part of the display screen by partly controlling the light emission of the point light sources 10.

In the case where each of the point light sources 10 is constructed by a single LED which emits light of R, G, or B or by a plurality of LEDs which separately emit light of three primary colors of R, G, and B, the arrangement direction is specified in accordance with the above-described rule color by color. A line segment of arrangement may become zigzag depending on arrangement of LEDs. In this case, it is sufficient to change the zigzag line to a straight line by averaging.

A pitch P₃ of the plurality of point light sources 10 in the arrangement direction L₁ is preferably equal to a pitch P₄ of the plurality of point light sources 10 in the arrangement direction L₂, but may be different from the pitch P₄.

The pitch of the plurality of point light sources 10 denotes to the interval (distance) of the point light sources 10 in the arrangement direction L₁ or L₂. In the case where each of the point light sources 10 is constructed by a single LED which emits light of R, G, or B or by a plurality of LEDs which separately emit light of three primary colors of R, G, and B, the pitch is specified in accordance with the above-described rule color by color.

The diffusing member 13 is, for example, a thick, high-rigid optical sheet having a light diffusion layer formed by dispersing a diffusion material (filler) in a relatively thick plate-shaped transparent resin, or a thin optical sheet formed by applying a transparent resin containing a light diffusion material on a relatively-thin film-shaped transparent resin. The diffusing member 13 has the function of diffusing light from the point light sources 10 and return light from the prism sheet 14 side. In the case where the diffusing member 13 is constructed by a high-rigid optical sheet, the diffusing member 13 also functions as a supporting member which supports other optical sheets (for example, the unevenness canceling sheets 11 and 12 and the prism sheet 14). The diffusing member 13 may be a combination of a diffusing member formed by dispersing a diffusing member (filler) in a relatively-thick plate-shaped transparent resin and a diffusing member formed by applying a transparent resin (binder) containing a diffusing member on a relatively-thin film-shaped transparent resin.

As the plate-shaped or film-shaped transparent resin, for example, a light-transmissive thermoplastic resin such as PET, acrylic, or polycarbonate is used. The light diffusion layer has a thickness of, for example, 1 mm to 5 mm both inclusive. The light diffusion material is made of particles having an average particle diameter of, for example, 0.5 μm to 10 μm both inclusive which are dispersed in a transparent resin in the range of 0.1 part by weight to 10 parts by weight both inclusive in the weight of the entire light diffusion layer. As the kind of the light diffusing member, for example, organic filler, inorganic filler, or the like may be used. Hollow particles may be also used as the light diffusing member.

When the light diffusion layer becomes thinner than 1 mm, diffuseness of light deteriorates, and there is also the possibility that sheet rigidity is not assured at the time of supporting the diffusing member 13 by a casing (not shown). If the light diffusion layer becomes thicker than 5 mm, when the diffusing member 13 is heated by light from the light source, it becomes difficult to release the heat, and there is the possibility that the diffusing member 13 is warped. In the case where the average particle diameter of the light diffusing member lies in the range of 0.5 μm to 10 μm both inclusive and the light diffusing member is dispersed in a transparent resin in the range of 0.1 part by weight to 10 parts by weight both inclusive in the weight of the entire light diffusion layer, the effect of the light diffusing member develops efficiently, and luminance non-uniformity is efficiently solved by the combination of the unevenness canceling sheets 11 and 12.

Although not shown, a diffusion sheet may be provided between the diffusing member 13 and the prism sheet 14, as a member different from the diffusing member 13. The diffusion sheet is, for example, a thin optical sheet formed by applying a transparent resin containing the light diffusing member on a relatively-thin film-shaped transparent resin. The diffusion sheet has a function of diffusing light which passed through the diffusing member 13 or the like.

Prism Sheet 14

The prism sheet 14 is, for example, as shown in FIG. 2, a thin optical sheet in which a plurality of projections 14A extending in a predetermined direction are arranged on the top face (the face on the light outgoing side). The prism sheet 14 makes a component in the arrangement direction of the projections 14A in light entering from the bottom side refracted and passed toward the direction normal to the bottom face, thereby increasing directivity and improving front-face luminance. Although the projection 14A has a triangular prism shape whose top is sharp in FIG. 2, for example, the top may be rounded or meandering. Although FIG. 2 illustrates the case where the projection 14A extends in a direction crossing the extension directions L₃ and L₄ of projections 11A and 12A (which will be described later) of the unevenness canceling sheets 11 and 12, they may extend in a direction parallel to or almost parallel to the extension direction L4 of the projection 12A of the unevenness canceling sheet 12.

A component in the arrangement direction of the projections 14A, in the light entering from the bottom face side of the prism sheet 14 does not easily pass through the projections 14A. By using this characteristic and properly changing the arrangement direction of the projections 14A in order to solve the luminance non-uniformity, the luminance non-uniformity is lessened. A plurality of prism sheets 14 may be used. In particular, in the case of using two prism sheets 14, it is preferable to set the arrangement directions of the projections 14A of the prism sheets 14 so as to be orthogonal or almost orthogonal to each other from the viewpoint of increasing directivity and improving the front-face luminance. Two prism sheets 14 may be disposed so that the extension direction of the projections 14A of the prism sheets 14 and the extension direction of the projections 11A and 12A of the unevenness canceling sheets 11 and 12 cross each other. In such a case, light in the extension direction of the projections 14A in the prism sheet 14 does not easily pass and, further light in the extension direction of the unevenness canceling sheets 11 and 12 does not easily pass, so that luminance non-uniformity is lessened.

The prism sheet 14 may be, for example, integrally formed by using a resin material having translucency such as one or more kinds of thermoplastic resins, or formed by transferring an energy line (such as ultraviolet) curable resin onto a translucent base material such as PET (polyethylene terephthalate).

It is preferable to use a thermoplastic resin having a refractive index of 1.4 or higher in consideration of the function of controlling the light emission direction. Examples of such a material include polycarbonate resin, acrylic resin such as PMMA (polymethylmethacrylate resin), polyolefin resin such as polyethylene (PE) or polypropylene (PP), polyester resin such as polyethylene terephthalate, amorphous copolymer polyester resin such as MS (copolymer of methylmethacrylate and styrene), polystyrene resin, polyvinyl chloride resin, cycloolefin resin, urethane resin, natural rubber resin, and artificial rubber resin and a combination of any of the resins.

The reflection sheet 15 is disposed in a position apart from a face 10A (refer to FIG. 1) including the plurality of point light sources 10 only by a predetermined gap and has a reflection face on the point light source 10 side. Preferably, the reflection face has not only the function of regular reflection but also the function of diffuse reflection. To make the functions of regular reflection and diffuse reflection develop, a reflection face obtained by coloring the resin to white may be used. In this case, it is preferable to obtain high ray reflection characteristic. Examples of such a material include polycarbonate resin and polybutylene terephthalate resin.

Preferably, in the reflection face of the reflection sheet 15, for example, each of regions opposed to the point light sources 10 has a flat face and regions which are not opposed to the point light sources 10 (regions opposed to regions each between neighboring point light sources 10) are entirely or partly made by dot-shaped diffusion members. In this case, scattered reflection tends to occur when light falls on the dot-shaped diffusing members, and light is easily emitted between the point light sources 10, so that luminance non-uniformity is reduced. As the material of the dot-shaped diffusing member, preferably, silicone resin or a transparent or white material such as silica or titania is used. The size of the diffusing member is preferably about 0.1 μm to 100 μm.

As shown in FIG. 2, the unevenness canceling sheet 11 is a thin optical sheet having a top face (face on the light emission side) on which the plurality of projections 11A (first three-dimensional structures) extending in a direction (extension direction L₃) parallel to or almost parallel to the arrangement direction L₁ of the point light sources 10 are arranged. On the other hand, the unevenness canceling sheet 12 is a thin optical sheet having a top face (face on the light emission side) on which the plurality of projections 12A (second three-dimensional structures) extending in a direction (extension direction L₄) parallel to or almost parallel to the arrangement direction L₂ of the point light sources 10 are arranged. That is, the extension direction L₃ of the projections 11A and the extension direction L₄ of the projections 12A cross each other. The unevenness canceling sheets 11 and 12 may be made of, for example, the same material as that of the prism sheet 14. A light diffusing material may be contained in the unevenness canceling sheet 12.

The projection 11A has a three-dimensional structure developing an optical characteristic of passing incident light from the point light source 10 side relative to the projection 12A. The projection 12A has a three-dimensional structure developing an optical characteristic of suppressing passage of incident light from the point light source 10 side relative to the projection 11A. Concretely, the projection 12A has a shape by which return light is generated from normal incident light more than the projection 11A.

In the case where the extension direction L₃ of the three-dimensional structures in the unevenness canceling sheet 11 is parallel or almost parallel to the arrangement direction L₁ of the point light sources 10 and the extension direction L₄ of the three-dimensional structures in the unevenness canceling sheet 12 is parallel or almost parallel to the arrangement direction L₂ of the point light sources 10, an excellent uneven state is realized. In this case, preferably, an angle θ₁ (not shown) formed between the arrangement direction L₁ and the extension direction L₃ or an angle θ₂ (not shown) formed between the arrangement direction L₂ and the extension direction L₄ is 10 degrees or less. Preferably, an angle θ₃ (not shown) formed between the extension direction L₃ and the extension direction L₄ lies in a range from 60 degrees to 120 degrees both inclusive. When the angle θ₁ exceeds 10 degrees, luminance non-uniformity in the arrangement direction L₁ and the extension direction L₃ deteriorates. When the angle θ₂ exceeds 10 degrees, luminance non-uniformity in the arrangement direction L₂ and the extension direction L₄ deteriorates. When the angle θ₃ exceeds the range, the extension direction L₃ and the extension direction L₄ become close to parallel to each other, so that the luminance non-uniformity in the long-side direction L_{L} and the short-side direction L_{S} of the unevenness canceling sheets 11 and 12 deteriorates.

The case of using a linear light source (not shown) in place of the point light source 10 in the illuminating device 1 of the embodiment and a display device on which the illuminating device 1 is mounted will be considered. Generally, for example, as disclosed in Japanese Unexamined Patent Application Publication No. 2006-140124, it is considered to be preferable to dispose an optical sheet or a diffuser plate having a three-dimensional structure extending in a certain direction so as to be in parallel to the longitudinal direction of the linear light source.

On the other hand, in the illuminating device 1 of the embodiment and the display device on which the illuminating device 1 is mounted, in the case where the extension direction L₃ of the three-dimensional structure in the unevenness canceling sheet 11 is parallel to or almost parallel to the arrangement direction L₁ of the point light sources 10, and the extension direction L₄ of the three-dimensional structure in the unevenness canceling sheet 12 is parallel to or almost parallel to the arrangement direction L₂ of the point light sources 10, an excellent uneven state is assured. There is a case that an excellent uneven state is realized rather when the extension direction L₃ is slightly deviated from the arrangement direction L₁ of the point light sources 10, and the extension direction L₄ is slightly deviated from the arrangement direction L₂ of the point light sources 10.

The expression that the projection 12A generates return light from the normal incident light more than the projection 11A roughly means that total light transmittance (JIS K 7361) of the unevenness canceling sheet 12 when light is allowed to enter normal to the unevenness canceling sheet 12 from the point light source 10 side is lower than that of the unevenness canceling sheet 11 when light is allowed to enter normal to the unevenness canceling sheet 11 from the point light source 10 side. It is almost equivalent that, concretely speaking with numerical values, the projections 11A and 12A satisfy the expressions (1) and (2) and also satisfy the expression (3).

P₃/H>1.3 (1)

P₄/H>1.3 (2)

20%>Tt1−Tt2>5% (3)

P₃ denotes a pitch in the arrangement direction L₁ of the point light sources 10. P₄ denotes a pitch in the arrangement direction L₂ of the point light sources 10. H denotes distance between the point light sources 10 and the unevenness canceling sheet 11. Tt1 indicates total light transmittance (%) of the unevenness canceling sheet 11 when light is allowed to enter normal to the unevenness canceling sheet 11 from the point light source 10 side. Tt2 indicates total light transmittance (%) of the unevenness canceling sheet 12 when light is allowed to enter normal to the unevenness canceling sheet 12 from the point light source 10 side.

In the case where a diffusing agent such as filler is not contained in the unevenness canceling sheets 11 and 12 and the diffuser plate exists on the unevenness canceling sheets 11 and 12, the projections 11A and 12A may be specified as follows. The projections 11A and 12A satisfy the expressions (4) and (5) and also satisfy the expressions (6) and (7).

P₃/H>1.3 (4)

P₄/H>1.3 (5)

0.1≦R₂/P₂<R₁/P₁<0.4 (6)

0.02<R₁/P₁−R₂/P₂<0.1 (7)

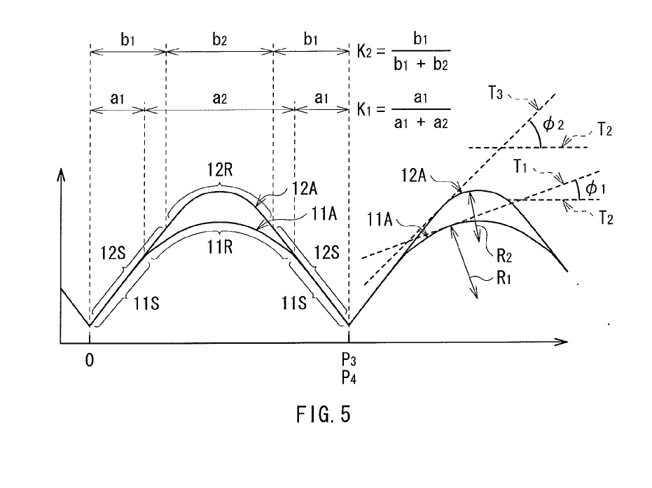

P₁ denotes a pitch in the arrangement direction of the plurality of projections 11A. P₂ denotes a pitch in the arrangement direction of the plurality of projections 12A. R₁ denotes curvature of the top 11R of the projection 11A as shown in FIG. 5. R₂ denotes curvature of the top 12R of the projection 12A. FIG. 5 shows that examples of the sectional shapes of the projections 11A and 12A overlap. φ₁ in FIG. 5 denotes an angle formed by a tangent line T₁ which is in contact with the projection 11A and a plane T₂ which is parallel to the back face of the unevenness canceling sheet 11, and φ₂ in FIG. 5 denotes an angle formed by a tangent line T₃ which is in contact with the projection 12A and a plane T₂ which is parallel to the back face of the unevenness canceling sheet 11.

In the case where each of φ₁ and φ₂ is less than 39°, the proportion of light passing through the surface of the projections 11A and 12A in light which enters normal to the back face of the unevenness canceling sheets 11 and 12 is more dominant than that of light which is reflected by the projections 11A and 12A and becomes return light. In the case where each of φ₁ and φ₂ exceeds 59°, although light which enters normal to the back face of the unevenness canceling sheets 11 and 12 is totally reflected by the surface of one of the projections 11A and 12A, the reflection light passes through the other surface of the projections 11A and 12A, and the transmission light does not enter the projections 11A and 12A again. Consequently, in this case as well, the proportion of light passing through the unevenness canceling sheets 11 and 12 in light which enters normal to the back face of the unevenness canceling sheets 11 and 12 is more dominant than that of light which is reflected by the unevenness canceling sheets 11 and 12 and becomes return light.

The upper and lower limits of the expressions (4) and (5) are specified by an unevenness ratio obtained by the following expression (6) and are set in a range that the unevenness ratio does not exceed 3%. The unevenness ratio of 3% is the upper limit that a human does not visually recognize display unevenness (or does not bother display unevenness) and is one of indices in display quality.

Unevenness ratio (%)=((maximum luminance−minimum luminance)/average luminance)×100 (6)

Preferably, φ₁ and φ₂ increase smoothly from the top of the projections 11A and 12A toward the bottom. For example, as shown in FIG. 5, in the case where the projection 11A has a three-dimensional structure of a triangular prism having a top 11R extending in a direction parallel to the arrangement direction L₁ of the point light source 10 and, on both sides of the top 11R, inclined surfaces 11S smoothly continued from the top 11R, preferably, the top 11R has a projection shape which projects to the light emission side, and the inclined surface 11S is a flat face. For example, as shown in FIG. 5, in the case where the projection 12A has a three-dimensional structure of a triangular prism having a top 12R extending in a direction parallel to the arrangement direction L₂ of the point light source 10 and, on both sides of the top 12R, inclined surfaces 12S smoothly continued from the top 12R, preferably, the top 12R has a projection shape which projects to the light emission side, and the inclined surface 12S is a flat face.

In the case where each of the projections 11A and 12A has a three-dimensional structure as shown in FIG. 5, when the inclination angles of the inclined surfaces 11S and 12S are equal to each other, naturally, the level of the top 11R is higher than that of the top 12R.

The projections 11A and 12A are not limited to the shapes shown as an example but may be deformed in the range satisfying the expressions (1) to (5).

When the ratio of a return light generation part a1 (first part) which generates return light traveling toward the point light source 10 side by total reflection of light entering from the point light source 10 normal to the unevenness canceling sheet 11, occupying the projection 11A when the unevenness canceling sheet 11 is seen from the normal direction of the plane 10A is set as K1 and the ratio of a return light generation part b1 (second part) which generates return light traveling toward the point light source 10 side by total reflection of light incident normal to the unevenness canceling sheet 12 in light which passed through the unevenness canceling sheet 11, in the projection 12A, occupying the projection 12A when the unevenness canceling sheet 12 is seen from the normal direction of the plane 10A is set as K2, preferably, K2 is larger than K1.

For example, in the case where the projection 11A has a three-dimensional structure as illustrated in FIG. 5, as illustrated in FIG. 5, the return light generation part a1 corresponds to the inclined surface 11S, and the part a2 other than the return light generation parts a1 in the projection 11A corresponds to the top 11R. For example, in the case where the projection 12A has a three-dimensional structure as illustrated in FIG. 5, the return light generation part b1 corresponds to the inclined surface 12S, and the part b2 other than the return light generation parts b1 in the projection 12A corresponds to the top 12R. The correspondence relations may not be satisfied depending on the inclination angle and the shapes of the inclined surfaces 11S and 12S and the surface shapes of the tops 11R and 12R.

Operation and Effect

Next, the operation and effect of the illuminating device 1 of the embodiment will be described.

In the illuminating device 1 of the embodiment, luminance non-uniformity of light emitted from the point light sources 10 is reduced by the unevenness canceling sheets 11 and 12, the resultant light is diffused by the diffusing member 13 to lessen the directivity. After that, the resultant light is collected by the prism sheet 14 where the front-face luminance and directivity are adjusted.

In the embodiment, the unevenness canceling sheet 11 in which the plurality of projections 11A extending in the direction parallel to the arrangement direction L₁ of the point light sources 10 and the unevenness canceling sheet 12 in which the plurality of projections 12A extending in the direction parallel to the arrangement direction L₂ of the point light sources 10 are stacked in order from the point light source 10 side. Consequently, luminance non-uniformity in the direction parallel to the arrangement direction L₁ of the point light sources 10 in light emitted from the plurality of point light sources 10 is lessened by the unevenness canceling sheet 11, and luminance non-uniformity in the direction parallel to the arrangement direction L₂ of the point light sources 10 is lessened by the unevenness canceling sheet 12.

The light entering into the back face of the unevenness canceling sheet 11 is almost linear light, and the light entering into the unevenness canceling sheet 12 is diffused light which is refracted and scattered by the unevenness canceling sheet 11. To make the amount of return light in the direction parallel to the arrangement direction L₁ and the extension direction L₃ and the amount of return light in the direction parallel to the arrangement direction L₂ and the extension direction L₄ equivalent to each other, the capability of generating return light in the unevenness canceling sheet 12 is requested to be higher than that of generating return light in the unevenness canceling sheet 11. Consequently, in the case where both of the capabilities are the same (typically, in the case where the shape and material of the projections 11A in the unevenness canceling sheet 11 and those of the projections 12A in the unevenness canceling sheet 12 are the same), the unevenness canceling effect of the unevenness canceling sheet 11 having much linear incident light is higher than that of the unevenness canceling sheet 12 having smaller linear incident light. Also in the case where the capability of generating return light in the unevenness canceling sheet 12 is lower than that of generating return light of the unevenness canceling sheet 11, the unevenness canceling effect of the unevenness canceling sheet 11 having much linear incident light is higher than that of the unevenness canceling sheet 12 having less linear incident light. As a result, a phenomenon such that unevenness disappears only in the arrangement direction L₁ and the extension direction L₃ and unevenness in the arrangement direction L₂ and the extension direction L₄ does not disappear and a phenomenon such that the parts above the point light sources 10 become abnormally dark only in the arrangement direction L₁ and the extension direction L₃ occur.

On the other hand, in the embodiment, the projection 12A in the unevenness canceling sheet 12 has a three-dimensional structure having light collecting effect (that is, satisfying the expressions (1) to (5)) relatively stronger than that of the projection 11A in the unevenness canceling sheet 11, and has a shape by which return light is generated more from normal incident light. With the configuration, the unevenness canceling effect of the unevenness canceling sheet 11 and that of the unevenness canceling sheet 12 are made almost equal. Consequently, the phenomenon such that unevenness disappears only in the arrangement direction L₁ and the extension direction L₃ and unevenness in the arrangement direction L₂ and the extension direction L₄ does not disappear and the phenomenon such that the parts above the point light sources 10 become abnormally dark only in the arrangement direction L₁ and the extension direction L₃ are prevented. Luminance non-uniformity and color unevenness caused by the point light sources 10 are reduced.

In the embodiment, an excellent unevenness state is realized in the case where the extension direction L₃ of the three-dimensional structure of the unevenness canceling sheet 11 is parallel to or almost parallel to the arrangement direction L₁ of the point light sources 10 and the extension direction L₄ of the three-dimensional structure of the unevenness canceling sheet 12 is parallel to or almost parallel to the arrangement direction L₂ of the point light sources 10. Preferably, an angle θ₁ formed between the arrangement direction L₁ and the extension direction L₃ or an angle θ₂ formed between the arrangement direction L₂ and the extension direction L₄ is 10 degrees or less. Preferably, an angle θ₃ formed between the extension direction L₃ and the extension direction L₄ lies in a range from 60 degrees to 120 degrees both inclusive. When the angle θ₁ exceeds 10 degrees, luminance non-uniformity in the arrangement direction L₁ and the extension direction L₃ deteriorates. When the angle θ₂ exceeds 10 degrees, luminance non-uniformity in the arrangement direction L₂ and the extension direction L₄ deteriorates. When the angle θ₃ exceeds the range, the extension direction L₃ and the extension direction L₄ become close to parallel to each other, so that the luminance non-uniformity in the long-side direction L_{L} and the short-side direction L_{S} of the unevenness canceling sheets 11 and 12 deteriorates.

In the embodiment, in the case where a light diffusing agent is contained in at least one of the unevenness canceling sheets 11 and 12, luminance non-uniformity and the color unevenness caused by the point light sources 10 is reduced by the scattering effect of the light diffusing agent. The amount of adding the light diffusing agent is preferably minute. For example, in the case of making the light diffusing agent contained in a transparent plate having a thickness of 2 mm and whose both faces are flat, preferably, total light transmittance when light is allowed to enter normal to the transparent plate to which the light diffusing material is added has a value which lies in the range of 81% to 93% both inclusive. The upper limit value is a limit value of the total light transmittance in the transparent plate, and the lower limit value is a value specified to a degree that the return light generation effect is not largely disturbed by addition of the light diffusing agent.

Generally, the luminance non-uniformity in a plane occurs when P₃/H or P₄/H is increased. There are two cases that P₃/H or P₄/H becomes large. One of the cases is that the distance H between the point light sources 10 and the unevenness canceling sheet 11 is narrowed to reduce the thickness, and the other case is that the number of point light sources 10 is reduced (the pitches P₃ and P₄ of the point light sources 10 are lowered), and lighting is reduced. The display device of the embodiment is suitable to both of the cases.

### Modifications

Although the two unevenness canceling sheets 11 and 12 are used in the foregoing embodiment, three or more unevenness canceling sheets may be used. When three or more unevenness canceling sheets are used, light of the point light sources 10 is controlled more easily, and it is suitable from the viewpoint of reducing luminance non-uniformity. However, in the case of using three or more unevenness canceling sheets, preferably, an optical sheet disposed in a position further from the point light sources 10 has more return light than an optical sheet disposed in a position closer to the point light sources 10. In the case of using three or more unevenness canceling sheets, the extension direction of the three-dimensional structures in at least one of the unevenness canceling sheets is parallel to or almost parallel to the arrangement direction L₁ of the point light sources 10. Further, preferably, the extension direction of the three-dimensional structures in at least one of the remaining unevenness canceling sheets is parallel to or almost parallel to the arrangement direction L₂ of the point light sources 10. In this case, the luminance non-uniformity in the arrangement directions L₁ and L₂ is reduced.

In the modification, preferably, one of the three or more unevenness canceling sheets has three-dimensional structures extending in a direction parallel to or almost parallel to the long-side direction L_{L} or the short-side direction L_{S} of the unevenness canceling sheets 11 and 12. In this case, unevenness in the direction is reduced. For example, as illustrated in FIG. 6, between the unevenness canceling sheet 12 and the diffusing member 13, an unevenness canceling sheet 16 having a plurality of three-dimensional structures (projections 16A) extending in the short-side direction L_{S} of the unevenness canceling sheet 11 and an unevenness canceling sheet 17 having a plurality of three-dimensional structures (projections 17A) extending in the long-side direction L_{L} of the unevenness canceling sheet 11 may be provided.

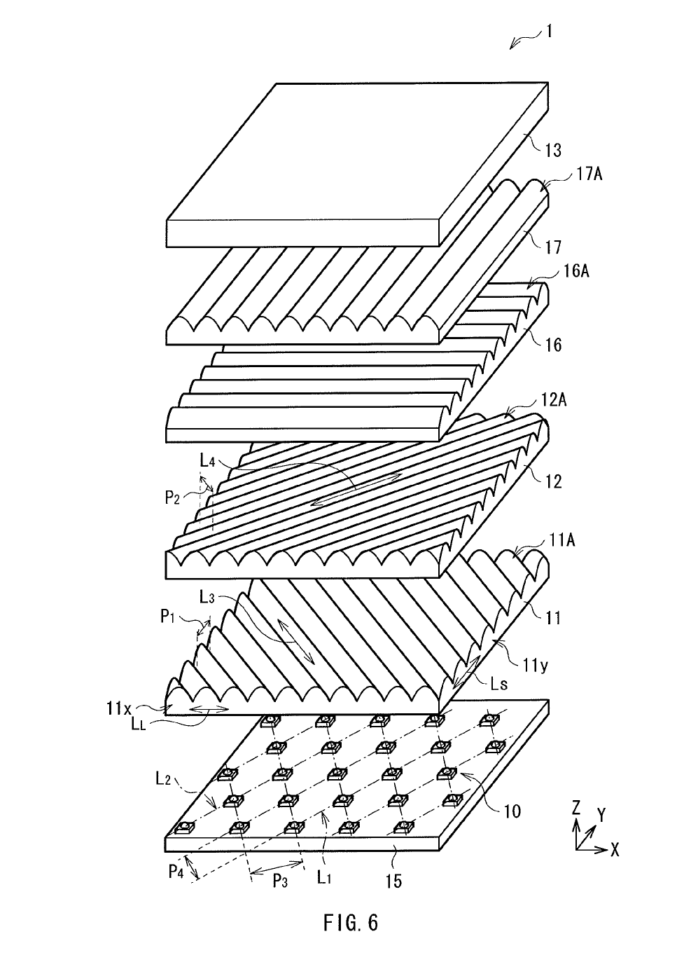

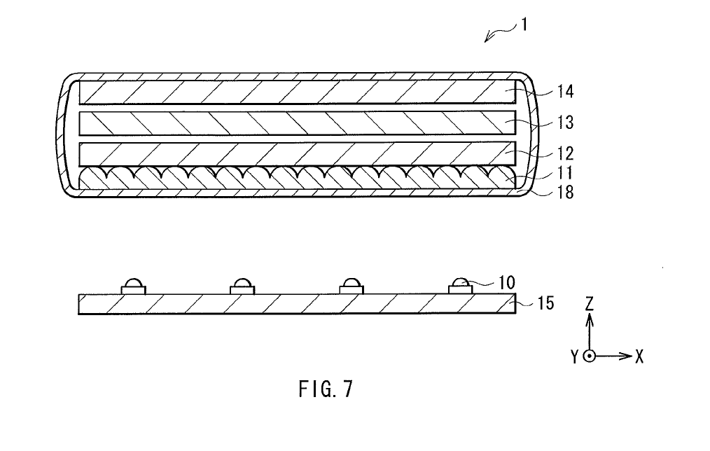

In the foregoing embodiment, the various optical sheets (for example, the unevenness canceling sheets 11 and 12, the diffusing member 13, and the prism sheet 14) disposed over the point light sources 10 are structurally independent of one another. In the case of using a relatively thick diffuser plate as the diffusing member 13 and using the diffusing member 13 as a supporting member, for example, as illustrated in FIG. 7, various optical elements may be covered with a flexible film 18. In such a case, even when amounts of expansion/contraction according to a temperature change of the various optical sheets over the point light sources 10 are different from each other, the various optical sheets are held in a casing (not shown) of the illuminating device 1 without causing a wrinkle in each of the optical sheets. When the unevenness canceling sheets 11 and 12 are disposed between the back face of the diffusing member 13 (the face on the point light source 10 side) and the flexible film 18 as shown in FIG. 7, it is unnecessary to increase rigidity of the unevenness canceling sheets 11 and 12 to prevent a warp or deflection. Consequently, the unevenness canceling sheets 11 and 12 are thinned to a degree which is almost the same as that in the case of providing the unevenness canceling sheets 11 and 12 on the top face of the diffusing member 13. With the configuration, also in the case where the unevenness canceling sheets 11 and 12 are provided just below the diffusing member 13, the illuminating device 1 is thinned.

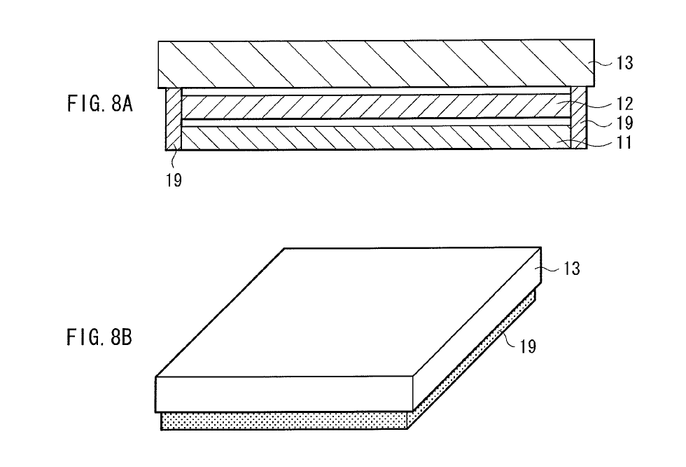

As illustrated in FIGS. 8A and 8B, by joining the periphery of the unevenness canceling sheets 11 and 12 and the periphery of the diffusing member 13 to each other by a joining part 19, the unevenness canceling sheets 11 and 12 and the diffusing member 13 may be structurally integrated. In the case of joining the unevenness canceling sheets 11 and 12 and the diffusing member 13 to each other by the joining part 19, the flexible film 18 is unnecessary. By joining the peripheries, there is no possibility that the joining part 19 is seen in the display screen.

Preferably, thermal adhesion or ultrasonic adhesion is used as a method of joining the periphery of the diffusing member 13 and the periphery of the unevenness canceling sheets 11 and 12. In this case, they are integrated with high productivity without using an intermediate agent. In particular, when the unevenness canceling sheets 11 and 12 and the diffusing member 13 are made of a thermoplastic resin (such as polycarbonate, polyethylene terephthalate, and polyethylene naphthalate), joining strength is increased by the adhesion.

In particular, it is preferable to integrate the unevenness canceling sheets 11 and 12 while tensioning them. To integrate the unevenness canceling sheets 11 and 12 in a state where there is no wrinkle or slack with the diffusing member 13, the unevenness canceling sheets 11 and 12 have to have thickness and rigidity to a certain degree. However, increase in thickness of the unevenness canceling sheets 11 and 12 is against reduction in thickness and cost of the illuminating device 1. Consequently, by integrating the unevenness canceling sheets 11 and 12 with the diffusing member 13 while tensioning the unevenness canceling sheets 11 and 12, the unevenness canceling sheets 11 and 12 are integrated without a wrinkle or slack.

Similarly, by joining the periphery of the diffusing member 13 and the periphery of the prism sheet 14 to each other by a joining part (not shown), the prism sheet 14 and the diffusing member 13 may be integrated. In this case, even when the prism sheet 14 is thinned, a wrinkle or slack does not easily occur. By joining the unevenness canceling sheets 11 and 12 on the point light source 10 side of the diffusing member 13 and joining the prism sheet 14 to the side opposite to the point light sources 10 while applying equivalent tension or stress, the unevenness canceling sheets 11 and 12, the diffusing member 13, and the prism sheet 14 may be integrated. This case is suitable also from the viewpoint that the diffusing member 13 does not warp easily. In a manner similar to the above, the unevenness canceling sheets 11 and 12 and the diffusing member 13 may be integrated by joining the periphery of the diffusing member 13 and the periphery of the unevenness canceling sheets 11 and 12 by a joining part (not shown). Further, by joining the periphery of the diffusing member 13 and the periphery of the prism sheet 14 to each other by a joining part (not shown), the prism sheet 14 and the diffusing member 13 may be integrated. In a manner similar to the above, it is unnecessary to increase rigidity of the unevenness canceling sheets 11 and 12 and the prism sheet 14 to prevent a warp or deflection, so that the unevenness canceling sheets 11 and 12 and the prism sheet 14 are thinned. Therefore, also in the case of providing the unevenness canceling sheets 11 and 12 just below the diffusing member 13, the illuminating device 1 is thinned.

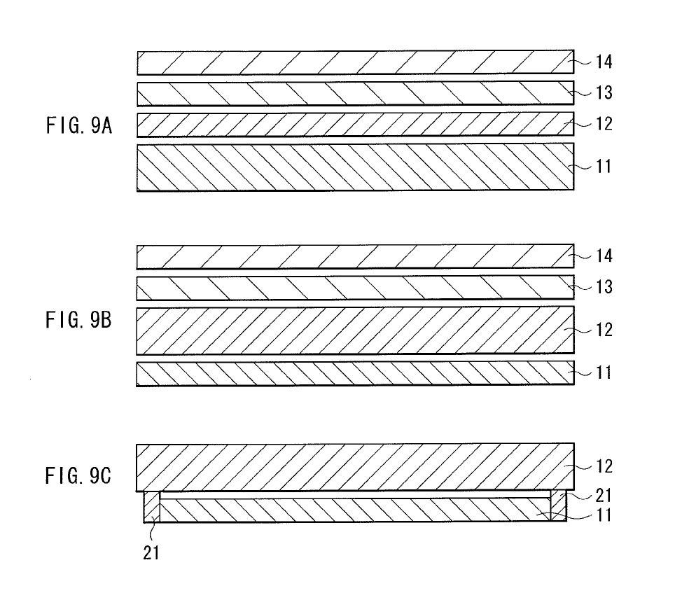

For example, as illustrated in FIG. 9A, the unevenness canceling sheet 11 may be thickened to have rigidity and used as a supporting member. As illustrated in FIG. 9B, the unevenness canceling sheet 12 may be thickened to have rigidity and used as a supporting member. As illustrated in FIG. 9C, by joining the periphery of the unevenness canceling sheet 11 and the periphery of the unevenness canceling sheet 12 to each other by a joining part 21, the unevenness canceling sheets 11 and 12 may be integrated.

In the case of using the unevenness canceling sheet 11 or 12 as a supporting member as illustrated in FIGS. 9A to 9C, from the viewpoint of rigidity of the supporting member, the thickness of any of the sheets is preferably 1 mm or more. By using the unevenness canceling sheet 11 or 12 as a supporting member, it is unnecessary to increase the rigidity of the other unevenness canceling sheet, and the illuminating device 1 is thinned.

In the case of using the unevenness canceling sheet 11 or 12 illustrated in FIGS. 9A to 9C as a supporting member, the diffusing member 13 does not have to be a diffuser plate functioning as a supporting member but may be a thin diffusion sheet. In the case where the diffusing member 13 is a thin diffusion sheet, it is preferable to increase diffusivity by making filler contained in the unevenness canceling sheet 11 or 12.

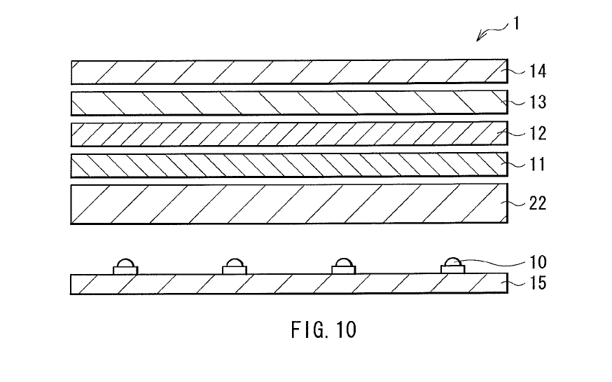

For example, a supporting member 22 may be disposed between the unevenness canceling sheets 11 and 12 and the point light sources 10 as illustrated in FIG. 10. As a result, it becomes unnecessary to increase the rigidity the unevenness canceling sheets 11 and 12, so that the unevenness canceling sheets 11 and 12 are thinned.

The supporting member 22 is made of, for example, transparent plastic material. Preferably, the supporting member 22 contains a minute amount of a light diffusing agent in accordance with, for example, the disposition and a light distribution of the point light sources 10 and height from the point light source 10 to the supporting member 22. In such a case, the luminance non-uniformity and the color unevenness caused by the point color sources 10 are reduced. The additive amount of the light diffusing agent is preferably a minute amount. For example, preferably, the additive amount has a value in a range where total light transmittance when light is allowed to enter normal to a transparent plate having a thickness of 2 mm, whose both sides are flat, and to which the light diffusing material is added is 81% to 93% both inclusive. 93% as the upper limit is the transmittance limit value of the transparent plate, and 81% as the lower limit is the lower limit value of the range in which the return light generation effect is not largely disturbed by addition of the diffusing agent.

As the material of the supporting member 22, any transparent resin having rigidity may be applied. For example, polymethylmethacrylate, cycloolefin polymer, zeonor (registered trademark of Zeon Corporation), polycarbonate, polystyrene, polyethylene terephthalate, or the like is suitable. In particular, polymethylmethacrylate, cycloolefin polymer, zeonor, or the like are suitable as the material of the supporting member 22 from the viewpoint of luminance. The thickness of the supporting member 22 is preferably 1 mm or more from the viewpoint of rigidity.

Similarly, also in the case of FIG. 10, the diffusing member 13 does not have to be a diffuser plate functioning as a supporting member but may be a thin diffusion sheet. In the case where the diffusing member 13 is a thin diffusion sheet, it is preferable to increase diffusivity by making filler contained in the unevenness canceling sheet 11 or the unevenness canceling sheet 12.

### EXAMPLES

Examples of the illuminating device 1 of the embodiment will now be described.

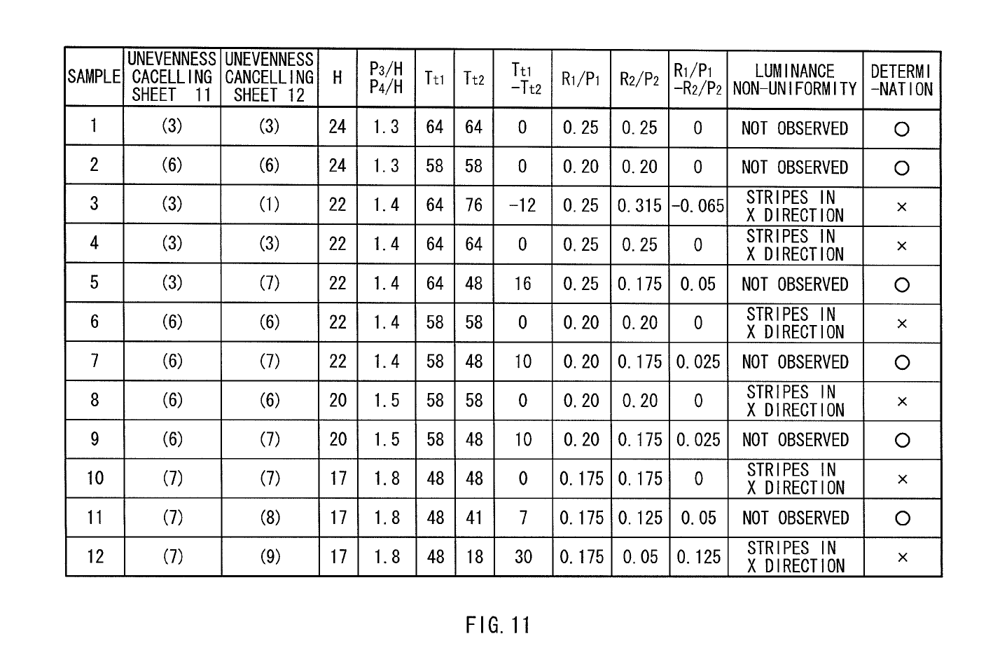

FIGS. 11 to 17 illustrate measurement results and determinations of luminance non-uniformity of samples 1 to 68 obtained while changing the configuration of the unevenness canceling sheets 11 and 12 in the illuminating device 1 and the distance H between the point light sources 10 and the unevenness canceling sheet 11.

The samples 1 to 68 were manufactured by disposing, on the point light sources 10, the unevenness canceling sheet 11, the unevenness canceling sheet 12, the diffusing member 13, the prism sheet 14, and a reflection-type polarization separation element (not shown) in order from the point light source 10 side and disposing the reflection sheet 15 on the rear face of the point light sources 10.

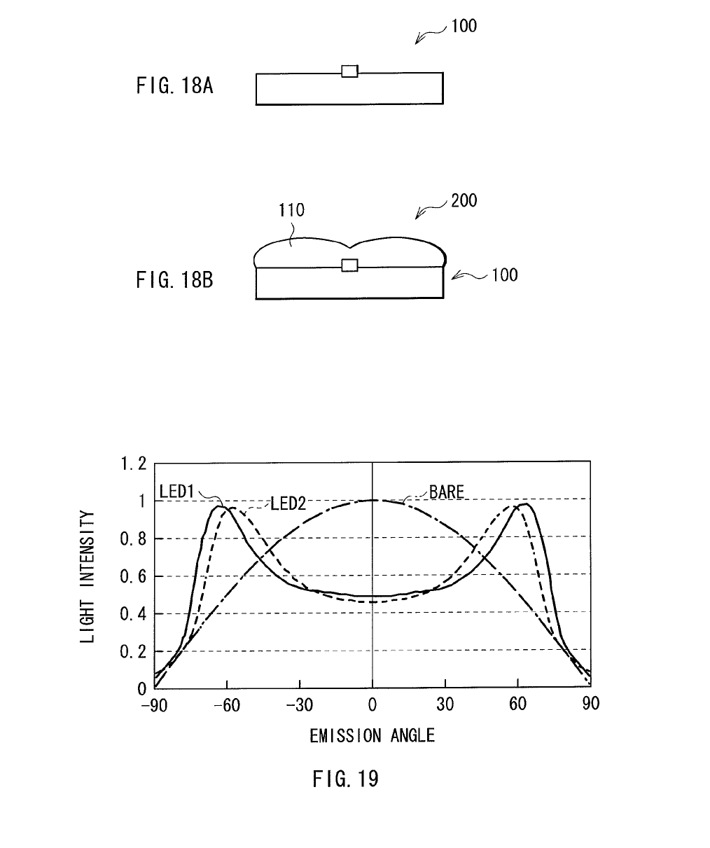

In the samples 1 to 12, 42 to 47, 51 to 56, and 60 to 65, a white LED (FIG. 18A) which is not subjected to processing such as capping was used as the point light source 10, and the pitches P₃ and P₄ were set to 30 mm. The white LED has the light distribution indicated by “BARE” in FIG. 19. In the samples 13 to 24, LEDs separately emitting light of the three primary colors of R, G, and B were used as the point light sources 10, and the pitches P₃ and P₄ were set to 40 mm. In the samples 1 to 24, no filler was added to the unevenness canceling sheets 11 and 12, and a diffuser plate having a total light transmittance of about 80% was used as the diffusing member 13. In the samples 25 to 34, LEDs separately emitting light of the three primary colors of R, G, and B were used as the point light sources 10, and the pitches P₃ and P₄ were set to 40 mm. In the samples 25 to 34, filler was added to the unevenness canceling sheet 12, and a diffuser sheet was used as the diffusing member 13.

In the samples 35 to 41, 48 to 50, 57 to 59, and 66 to 68, a wide-directivity-angle LED (FIG. 18B) obtained by capping a white LED was used as the point light source 10. In the samples 35 to 38, 48, 49, 57, 58, 66, and 67, a wide-directivity-angle LED having a light distribution indicated as “LED1” in FIG. 19 was used as the wide-directivity-angle LED, and the pitches P₃ and P₄ were set to 26 mm. In the samples 39 to 41, 50, 59, and 68, a wide-directivity-angle LED having a light distribution indicated as “LED2” in FIG. 19 was used as the wide-directivity-angle LED, and the pitches P₃ and P₄ were set to 26 mm.

In the samples 1 to 41, the angle formed by the arrangement directions L₁ and L₂ of the point light sources 10 and the extension directions L₃ and L₄ of the three-dimensional structures in the unevenness canceling sheets 11 and 12 was set to 45 degrees, and the angle formed by the extension directions L₃ and L₄ of the three-dimensional structures in the unevenness canceling sheets 11 and 12 and the long-side direction L_{L} of the unevenness canceling sheet 11 was set to 45 degrees. In the following description, the angle having the smaller absolute value among the angles formed by the arrangement directions L₁ and L₂ and the extension directions L₃ and L₄ and the long-side direction L_{L} of the unevenness canceling sheet 11 will be described. The angle in the clockwise direction when seen from the long side Lx of the unevenness canceling sheet 11 will be described as +, and the angle in the counterclockwise direction will be described as −. Specifically, the angle formed by the long side Lx of the unevenness canceling sheet 11 and the extension directions L₃ and L₄ is +45 degrees, but the angle formed by the long side Lx of the unevenness canceling sheet 11 and the arrangement direction L₂ and the extension direction L₄ is −45 degrees. In the description, in the samples 1 to 41, the arrangement direction L₁ is +45 degrees, the arrangement direction L₂ is −45 degrees, the extension direction L₃ is +45 degrees, and the extension direction L₄ is −45 degrees.

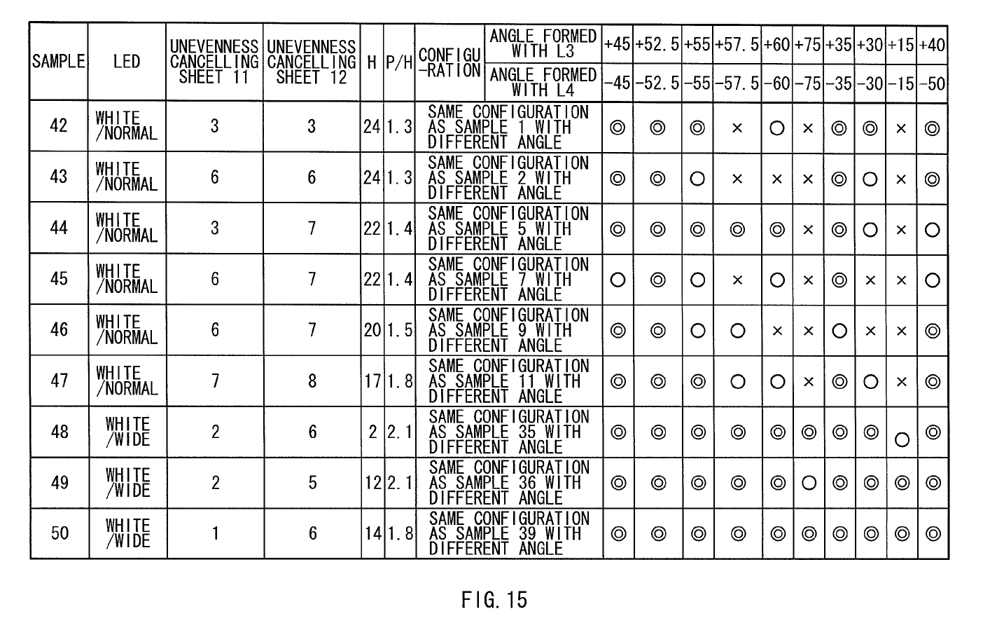

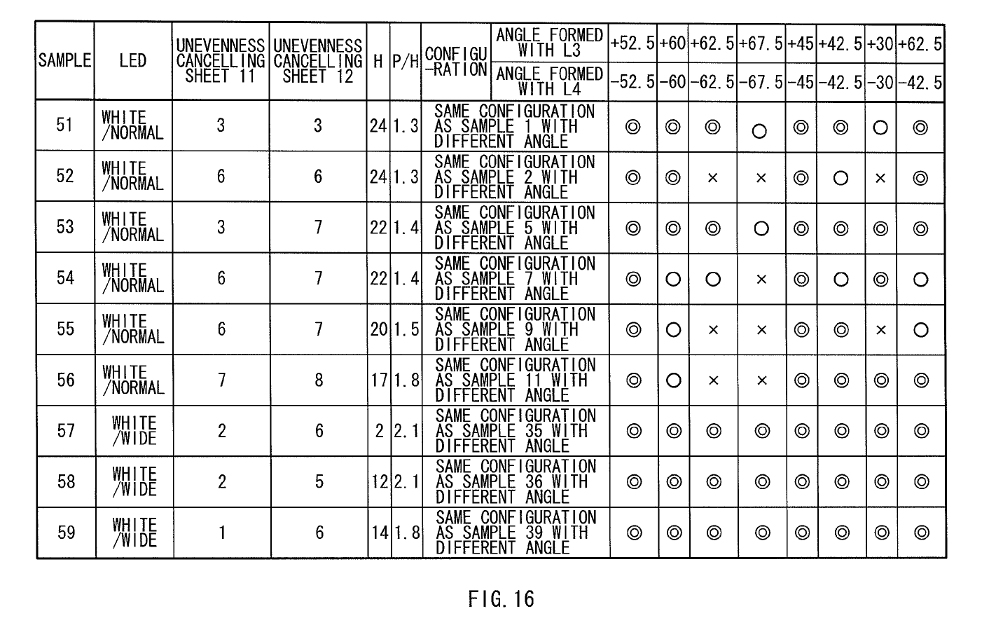

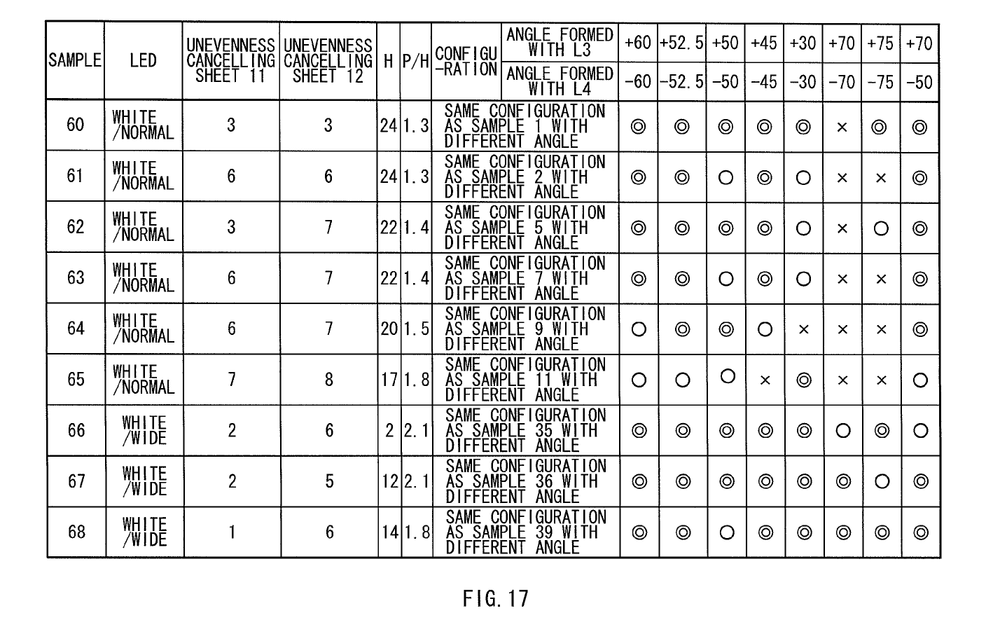

FIGS. 15, 16, and 17 illustrate samples 42 to 68 obtained by changing the arrangement directions L₁ and L₂ of LEDs and changing the extension directions L₃ and L₄ of the three-dimensional structures in the unevenness canceling sheets 11 and 12 by using the configurations of the samples 1, 2, 5, 7, 9, 11, 35, 36, and 39 using a single white LED hardly having unevenness. FIG. 15 illustrates the samples 42 to 50 as results of changing the angles of the extension directions L₃ and L₄ in a state where the arrangement direction L₁ is +45 degrees and the arrangement direction L₂ is −45 degrees. FIG. 16 illustrates the samples 51 to 59 as results of changing the angles of the extension directions L₃ and L₄ in a state where the arrangement direction L₁ is +52.5 degrees and the arrangement direction L₂ is −52.5 degrees. FIG. 17 illustrates the samples 60 to 68 as results of changing the angles of the extension directions L₃ and L₄ in a state where the arrangement direction L₁ is +60 degrees and the arrangement direction L₂ is −60 degrees.

In FIGS. 15, 16, and 17, when the unevenness ratio is less than 3%, circle is written. When the unevenness ratio is 3% or higher, cross is written. When the unevenness ratio is less than 2.5%, double circle is written which shows that the sample has smaller unevenness than that with circle.

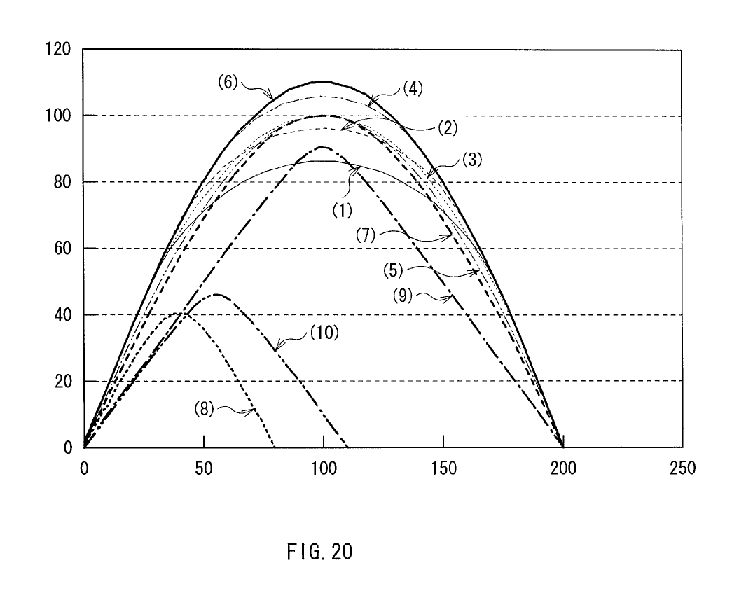

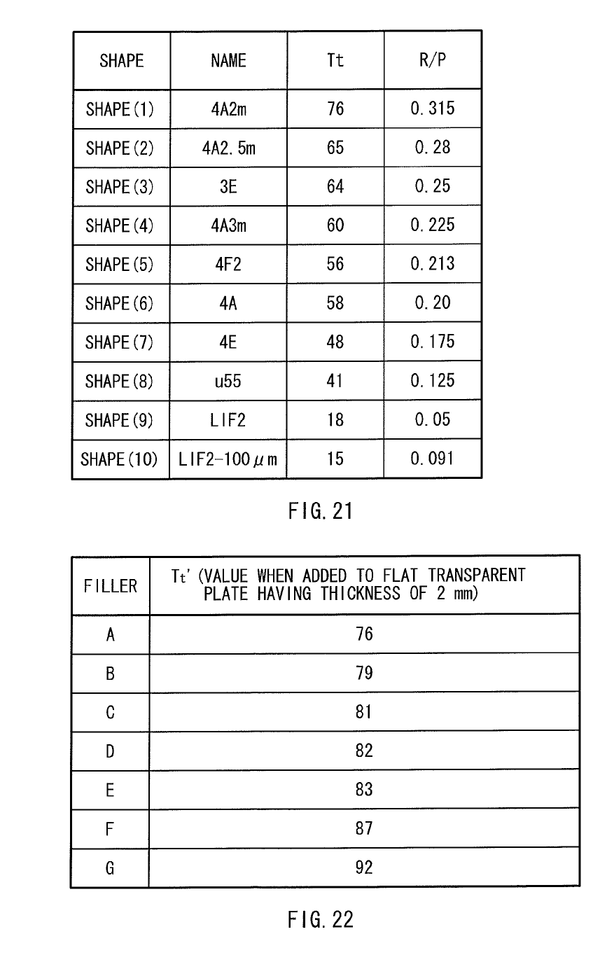

In the samples 1 to 34, as the projections 11A and 12A of the unevenness canceling sheets 11 and 12, projections having sectional shapes and optical characteristics as illustrated in FIGS. 20 and 21 were selected, and the diffusing member 13 having a transmittance of about 80% was used. In the samples 24 to 34, the filler as illustrated in FIG. 22 was selected as filler to be added to the unevenness canceling sheet 12.

From FIG. 11, the following was known. In the case of using the unevenness canceling sheets 11 and 12 and the diffusing plate, in the samples 5, 7, 9, and 11 in which when P₃/H>1.3 and P₄/H>1.3, 20>Tt1−Tt2>5 is satisfied, no unevenness was observed. When P₃/H<1.3 and P₄/H<1.3, no unevenness was observed even when the shapes of the unevenness canceling sheets 11 and 12 were not changed. The samples 5, 7, 9, and 11 in which no unevenness was observed satisfy 0.1≦R₂/P₂<R₁/P₁<0.4 and 0.02<R₁/P₁−R₂/P₂<0.1.

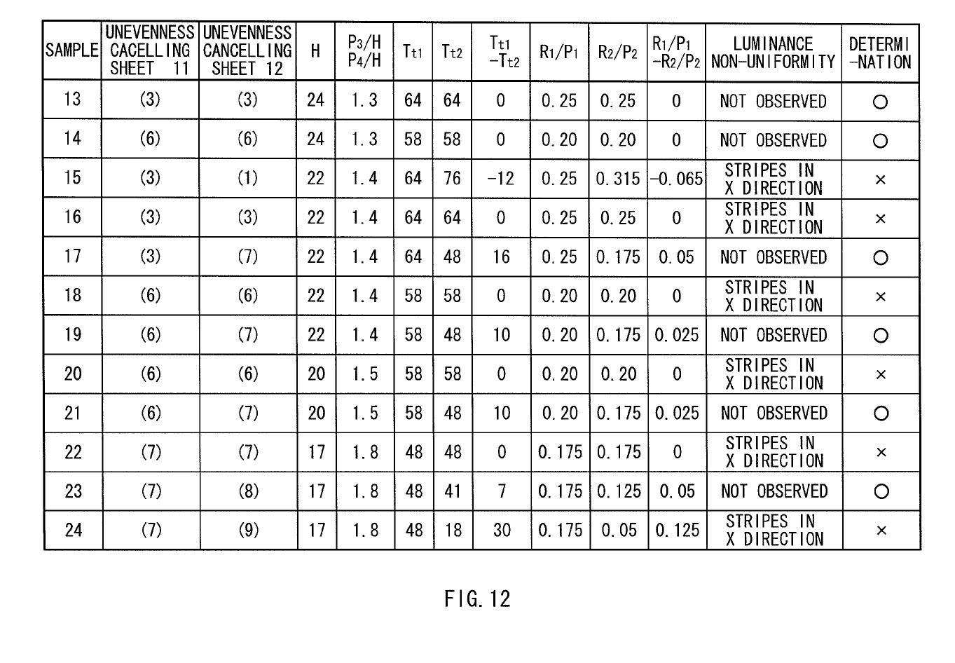

In FIG. 12, like FIG. 11, the above expressions were satisfied also in the case of using the three-color LEDs as the light source. The samples 17, 19, 21, and 23 satisfy the following relational expression group A or B.

Relational Expression Group A

P₃/H>1.3

P₄/H>1.3

20%>Tt1−Tt2>5%

Relational Expression Group B

P₃/H>1.3

P₄/H>1.3

0.1≦R₂/P₂<R₁/P₁<0.4

0.02<R₁/P₁−R₂/P₂<0.1

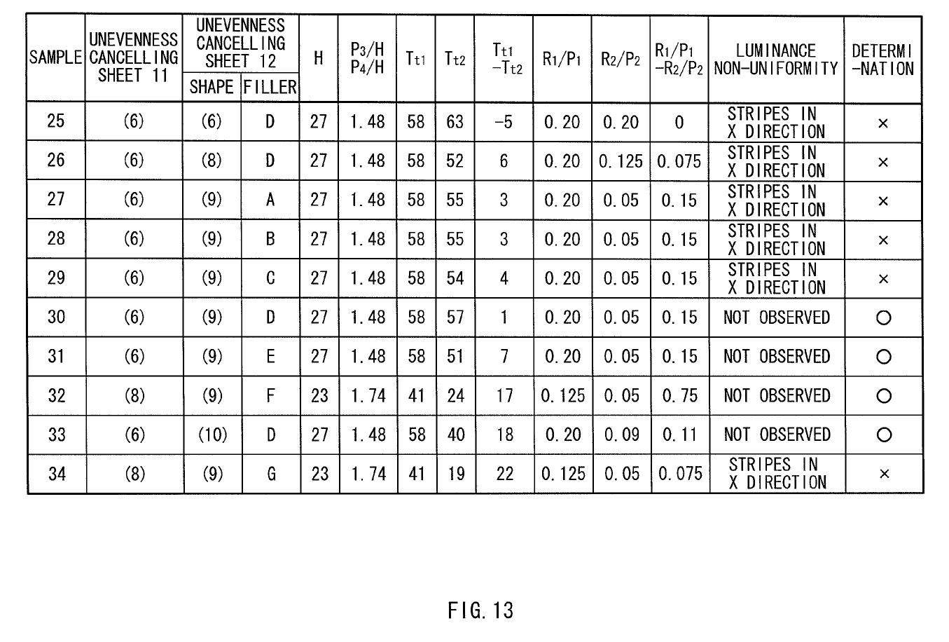

From FIG. 13, the following was known. In the case of using the unevenness canceling sheet 11, the unevenness canceling sheet 12 containing filler, and the diffusing sheet, in the samples 30 to 33 in which no unevenness was observed, when P₃/H>1.3 and R₄/H>1.3, 20>Tt1−Tt2>5 is satisfied. Similarly, R₂/P₂<0.1 is satisfied. The proper amounts of filler to be added to the unevenness canceling sheet 12 are C, D, E, and F which have values in a range where total light transmittance Tt′ when light is allowed to enter normal to a transparent plate having a thickness of 2 mm, whose both sides are flat, and to which the same amount of the light diffusing material is added is 81% to 93% both inclusive.

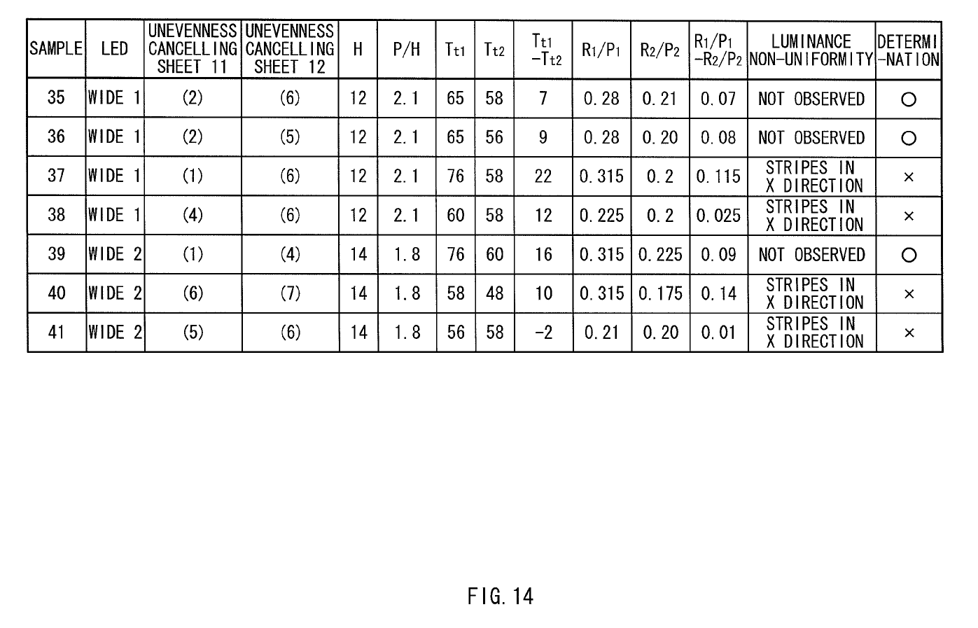

In FIG. 14, like FIGS. 11 and 12, the samples 35, 36, and 39 in which no unevenness was observed also in the case of using the wide-directivity-angle LED with a cap as the light source satisfy the following relational expression group A or B.

Relational Expression Group A

P₃/H>1.3

P₄/H>1.3

20%>Tt1−Tt2>5%

Relational Expression Group B

P₃/H>1.3

P₄/H>1.3

0.1≦R₂/P₂<R₁/P₁<0.4

0.02<R₁/P₁−R₂/P₂<0.1

It was understood from FIG. 15 that the arrangement directions L₁ and L₂ of the point light sources 10 and the extension directions L₃ and L₄ of the three-dimensional structures of the unevenness canceling sheets 11 and 12 have to be almost parallel to each other. In FIG. 15, the angle formed by the arrangement directions L₁ and L₂ of the point light sources 10 and the long-side direction Lₓ of the unevenness canceling sheet 11 is ±45 degrees.

In this case, until the angle formed by the extension directions L₃ and L₄ of the three-dimensional structures of the unevenness canceling sheets 11 and 12 and the long-side direction Lx of the unevenness canceling sheet 11 is ±55 degrees, that is, in the case where the angle formed by the extension directions L₃ and L₄ and the arrangement directions L₁ and L₂ is 10 degrees or less, unevenness is hardly seen. However, when the angle formed by the extension directions L₃ and L₄ and the long-side direction Lₓ of the unevenness canceling sheet 11 becomes ±57.5 degrees (that is, the angle formed by the extension directions L₃ and L₄ and the arrangement directions L₁ and L₂ is 12.5 degrees), deterioration occurred to the degree that unevenness was visibly recognized in the samples 42, 43, and 45.

Similarly, when the angle formed by the extension directions L₃ and L₄ and the long-side direction Lₓ of the unevenness canceling sheet 11 becomes ±35 degrees (that is, the angle formed by the extension directions L₃ and L₄ and the arrangement directions L₁ and L₂ is 10 degrees), unevenness is hardly seen. However, when the angle formed by the extension directions L₃ and L₄ and the long-side direction Lₓ of the unevenness canceling sheet 11 becomes ±30 degrees (that is, the angle formed by the extension directions L₃ and L₄ and the arrangement directions L₁ and L₂ is 15 degrees), deterioration occurred to the degree that unevenness was visibly recognized in the samples 45 and 46. As described above, when the angle formed by the extension directions L₃ and L₄ and the arrangement directions L₁ and L₂ increases, the effect of reducing unevenness in the arrangement directions L₁ and L₂ of the point light sources decreases, and unevenness becomes worse.

The absolute values of the angle formed by the extension directions L₃ and L₄ and the long-side direction Lₓ of the unevenness canceling sheet 11 do not have to be symmetrical. For example, the extension direction L₃ may be +40 degrees, and the extension direction L₄ may be −50 degrees. Although not shown, when the angle formed by the arrangement direction L₁ and the extension direction L₃ and the angle formed by the arrangement direction L₂ and the extension direction L₄ is 10 degrees or less, and the angle formed by the extension directions L₃ and L₄ lies in the range of 60 to 120 degrees both inclusive, a state where unevenness is hardly observed is obtained by any of the combinations.

It was understood from FIG. 15 that, in wide light distribution, unevenness was hardly seen regardless of the angle formed by the extension directions L₃ and L₄ and the long-side direction Lₓ of the unevenness canceling sheet 11. In the wide light distribution, light emitted obliquely from an LED is stronger than light emitted vertically from the LED. Consequently, dependency on the extension directions L₃ and L₄ of the unevenness canceling sheets 11 and 12, of the distributions of reflection light from the unevenness canceling sheets 11 and 12 is smaller than that in normal light distribution. Consequently, the angle formed by the arrangement directions L₁ and L₂ and the extension directions L₃ and L₄ may be set in a range wider than that in normal light distribution.

For example, in the sample 48, however, the unevenness in the case where the angle formed by the extension directions L₃ and L₄ and the long-side direction Lₓ of the unevenness canceling sheet 11 is ±15 degrees (that is, the angle formed by the extension directions L₃ and L₄ and the arrangement directions L₁ and L₂ is 30 degrees) is compared with the unevenness in the case where the angle is ±45 degrees (that is, the angle formed by the extension directions L₃ and L₄ and the arrangement directions L₁ and L₂ is 0 degrees), unevenness is smaller when the angle formed by the arrangement directions L₁ and L₂ and the extension directions L₃ and L₄ is smaller.

Similarly, in the sample 49, the unevenness in the case where the angle formed by the extension directions L₃ and L₄ and the long-side direction Lₓ of the unevenness canceling sheet 11 is ±75 degrees (that is, the angle formed by the extension directions L₃ and L₄ and the arrangement directions L₁ and L₂ is 30 degrees) is compared with the unevenness in the case where the angle is ±45 degrees (that is, the angle formed by the extension directions L₃ and L₄ and the arrangement directions L₁ and L₂ is 0 degrees), unevenness is smaller when the angle formed by the arrangement directions L₁ and L₂ and the extension directions L₃ and L₄ is smaller. From the above, also in the wide light distribution, preferably, the arrangement directions L₁ and L₂ of the point light sources 10 and the extension directions L₃ and L₄ of the three-dimensional structures of the unevenness canceling sheets 11 and 12 are almost parallel to each other.

In the samples 37, 38, 40, and 41, the unevenness is bad to a degree that it is visibly recognized. Also in the wide light distribution, a shape by which return light is generated from normal incident light more from the unevenness canceling sheet 12 than the unevenness canceling sheet 11 is preferable.

In the sample 45, the unevenness in the case where the angle formed by the extension directions L₃ and L₄ and the long-side direction Lₓ of the unevenness canceling sheet 11 is ±52.5 or ±35 degrees is smaller than that in the case where the angle formed by the extension directions L₃ and L₄ and the long-side direction Lₓ of the unevenness canceling sheet 11 is ±45 degrees (that is, the extension directions L₃ and L₄ are completely parallel to the arrangement directions L₁ and L₂). That is, in the sample 45, unevenness is reduced more when the extension directions L₃ and L₄ and the arrangement directions L₁ and L₂ are slightly shifted from parallelism.

As described above, in the case of using a linear light source, the extension direction of the three-dimensional structures is preferably disposed in parallel to the linear light source. However, with respect to the point light source 10 in the embodiment, it was found that unevenness is hardly observed when the extension directions L₃ and L₄ and the arrangement directions L₁ and L₂ are almost parallel to each other and there is even a case that unevenness is reduced more when the directions are shifted slightly from parallelism.

FIG. 16 illustrates the angle formed by the extension directions L₃ and L₄ of the three-dimensional structures of the unevenness canceling sheets 11 and 12 and the long-side direction Lₓ of the unevenness canceling sheet 11 and the unevenness states when the angle formed by the arrangement directions L₁ and L₂ of the point light sources 10 and the long-side direction Lₓ of the unevenness canceling sheet 11 is ±52.5 degrees. It is understood from FIG. 16 that unevenness is hardly observed when the angle formed by the arrangement directions L₁ and L₂ of the point light sources 10 and the extension directions L₃ and L₄ of the three-dimensional structures of the unevenness canceling sheets 11 and 12 is 10 degrees or less and the angle formed between the extension directions L₃ and L₄ is in the range of 60 degrees to 120 degrees both inclusive.

In the example of FIG. 16, when the angle formed by the extension directions L₃ and L₄ of the long-side direction Lx of the unevenness canceling sheet 11 is ±60 degrees, the angle formed between the arrangement direction L₁ and the extension direction L₃ is 7.5 degrees, the angle formed between the arrangement direction L₂ and the extension direction L₄ is 10 degrees or less, and the angle formed between the arrangement direction L₃ and the extension direction L₄ is 120 degrees. In all of the samples illustrated in FIG. 16, unevenness is hardly observed.

On the other hand, when the angle formed by the extension directions L₃ and L₄ and the long-side direction Lₓ of the unevenness canceling sheet 11 is ±62.5 degrees, each of the angle formed by the arrangement direction L₁ and the extension direction L₃ and the angle formed by the arrangement direction L₂ and the extension direction L₄ is 10 degrees. However, when the angle formed by the extension directions L₃ and L₄ is 125 degrees which exceeds 120 degrees. In the samples 55 and 56 shown in FIG. 16, the unevenness became worse to the degree that unevenness was visibly recognized. As described above, when the angle formed by the extension directions L₃ and L₄ exceeds the range of 60 degrees to 120 degrees both inclusive, the extension directions L₃ and L₄ come to close to be parallel to each other, and unevenness in the long-side direction Lₓ or the short-side direction Lₛ of the unevenness canceling sheet 11 becomes worse.

On the other hand, when the angle formed by the extension directions L₃ and L₄ and the long-side direction Lₓ of the unevenness canceling sheet 11 is ±30 degrees, the angle formed by the extension direction L₃ and the extension direction L₄ is in the range of 60 degrees to 120 degrees both inclusive. However, when the extension directions L₃ and L₄ are too apart from the arrangement directions L₁ and L₂, so that samples in which unevenness became worse to the degree that unevenness was visibly recognized were found (for example, the samples 52 and 55).

The case where the angle formed by the extension directions L₃ and L₄ is ±45 degrees and the case where the angle is ±60 degrees are compared with each other. The angle formed by the arrangement directions L₁ and L₂ is 7.5 degrees, but unevenness in n the former case where the angle is ±45 degrees is relatively smaller than that in the latter case where the angle is ±60 degrees. Further, when the angle formed by the extension directions L₃ and L₄ is ±52.5 degrees, unevenness is hardly seen in all of the samples. Consequently, the angle formed between the extension directions L₃ and L₄ is preferably in the range of 60 degrees to 120 degrees both inclusive, more preferably, in the range of 75 degrees to 105 degrees both inclusive, and further more preferably, almost the right angle. The angles are suitable to reduce the unevenness in the long-side direction Lₓ and the short-side direction Lₛ of the unevenness canceling sheet 11.

The angle formed between the extension directions L₃ and L₄ is in the range of 60 degrees to 120 degrees both inclusive. However, when the angle formed between the extension directions L₃ and L₄ and the arrangement directions L₁ and L₂ is large, and the extension directions L₃ and L₄ become not parallel to the arrangement directions L₁ and L₂, the unevenness state became worse.

The absolute values of the angle formed by the extension directions L₃ and L₄ and the long-side direction Lₓ of the unevenness canceling sheet 11 do not have to be symmetrical. For example, in the case where the angle formed by the extension direction L₃ and the long-side direction Lₓ of the unevenness canceling sheet 11 is +62.5 degrees, and the angle formed by the extension direction L₄ and the long-side direction Lₓ of the unevenness canceling sheet 11 is −42.5 degrees, the angle formed by the arrangement direction L₁ and the extension direction L₃ and the angle formed by the arrangement direction L₂ and the extension direction L₄ are 10 degrees or less, and the angle formed between the extension directions L₃ and L₄ is in the range of 60 degrees to 120 degrees both inclusive. In all of the samples illustrated in FIG. 16, unevenness is hardly observed.

FIG. 17 illustrates the angle formed by the extension directions L₃ and L₄ of the three-dimensional structures of the unevenness canceling sheets 11 and 12 and the long-side direction Lₓ of the unevenness canceling sheet 11 and the unevenness states when the angle formed by the arrangement directions L₁ and L₂ of the point light sources 10 and the long-side direction Lₓ of the unevenness canceling sheet 11 is ±60 degrees. It is understood from FIG. 17 that unevenness is hardly observed when the angle formed by the arrangement directions L₁ and L₂ of the point light sources 10 and the extension directions L₃ and L₄ of the three-dimensional structures of the unevenness canceling sheets 11 and 12 is 10 degrees or less and the angle formed between the extension directions L₃ and L₄ is in the range of 60 degrees to 120 degrees.

For example, in FIG. 17, when the angle formed by the extension directions L₃ and L₄ and the long-side direction Lx of the unevenness canceling sheet 11 is ±50 degrees, unevenness is hardly observed in all of the samples 60 to 68 illustrated in FIG. 17. However, when the angle formed between the extension directions L₃ and L₄ and the long-side direction Lₓ of the unevenness canceling sheet 11 is ±70 degrees, the unevenness became worse to a degree that unevenness is visibly observed in the samples 60 to 65. It was understood from FIG. 17 that the angle between the point light sources 10 and the angles of the unevenness canceling sheets 11 and 12 is ten degrees in both of the two cases. However, the unevenness state changes according to the angle formed by the extension directions L₃ and L₄.

It was known from the samples 64 and 65 that there is a case that unevenness is reduced in the case where the arrangement directions L₁ and L₂ of the point light sources 10 and the extension directions L₃ and L₄ of the three-dimensional structures of the unevenness canceling sheets 11 and 12 are less parallel to each other (±50 degrees in the sample 64 and ±30 degrees in the sample 65) than the case where they are parallel to each other (when the angle formed between the extension directions L₃ and L₄ and the long-side direction Lₓ of the unevenness canceling sheet 11 is ±60 degrees).

From FIGS. 16 and 17, the angle formed between the arrangement directions L₁ and L₂ of the point light sources 10 and the long-side direction L_{L} of the unevenness canceling sheet 11 is not limited to ±45 degrees shown in the samples 1 to 49 but may be properly freely set by a matrix of arrangement of the point light sources 10.

As described above, the arrangement of the point light sources 10 slightly varies according to the size of the illuminating device 1 and the display device on which the illuminating device 1 is mounted. The arrangement of the point light sources 10 also varies depending on the method of determining the blocks on the circuit of the point light sources 10 at the time of giving the function of suppressing unnecessary light emission in a dark part in the display screen by partly controlling the light emission of the point light sources 10.

Although not illustrated, for example, in the case where the angle formed between the arrangement directions L₁ and L₂ and the long-side direction L_{L} of the unevenness canceling sheet 11 is ±30 degrees, the result is the same as that of FIG. 17 from the viewpoint of symmetry. That is, the angle formed between the arrangement directions L₁ and L₂ and the long-side direction L_{L} of the unevenness canceling sheet 11 may be ±45 degrees or less.

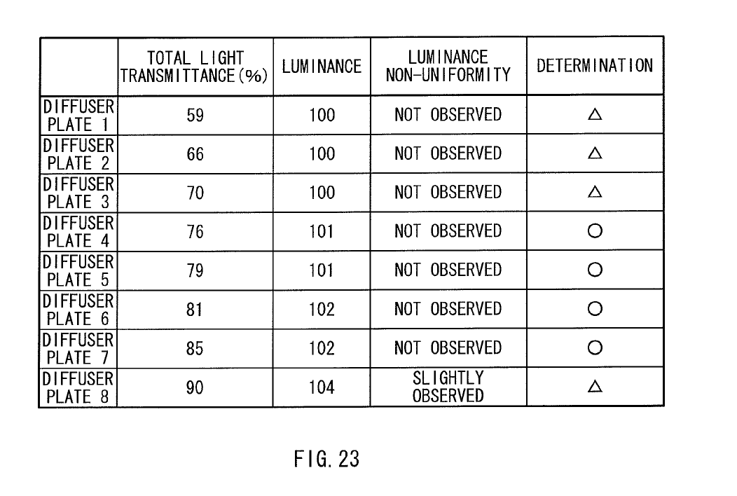

FIG. 23 shows total light transmittance of diffuser plates 1 to 8, luminance and luminance non-uniformity obtained when the unevenness canceling sheets 11 and 12, the diffuser plate, the prism sheet 14, and the reflection-type polarization separation device are stacked in order from the point light source 10 side on the point light sources 10 and the reflection sheet 15 is disposed on the back face of the point light sources 10, and determination. It was understood from FIG. 23 that the diffuser plates 1 to 7 (having transmittance of 60 to 85%) are suitable from the viewpoint of no luminance non-uniformity and color unevenness, and the diffuser plates 4 to 7 (having transmittance of 76 to 85%) have superiority from the viewpoint of luminance.

### Application Example

Next, the case of applying the illuminating device 1 of the embodiment to a display device will be described. In the following, the case of applying the illuminating device 1 having the configuration illustrated in FIG. 1 will be described. Obviously, the illuminating device 1 having another configuration may be also applied to a display device.

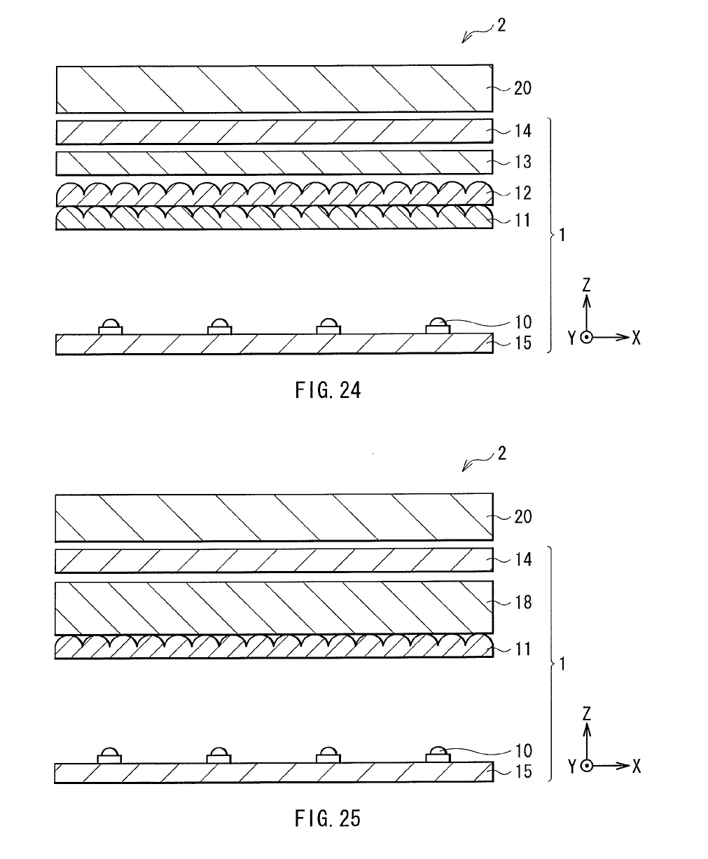

FIG. 24 illustrates a sectional configuration of a display device 2 according to the application example. The display device 2 has a display panel 20, and the illuminating device 1 in which the prism sheet 14 is disposed so as to be opposed to the display panel 20 side, and the surface of the display panel 20 is directed to an observer (not shown) side.

The display panel 20 has, although not illustrated, a layer stack structure having a liquid crystal layer between a transparent substrate on the observation side and a transparent substrate on the illuminating device 1 side. Concretely, the display panel 20 has, in order from the observation side, a polarizer, a transparent substrate, a color filter, a transparent electrode, an alignment film, a liquid crystal layer, an alignment film, a transparent pixel electrode, a transparent substrate, and a polarizer.

The polarizer is a kind of an optical shutter and allows only light in a predetermined oscillation direction (polarized light) to pass. The polarizers are disposed so that their polarization axes are different from each other by 90 degrees. With the configuration, light emitted from the illuminating device 1 passes through or is blocked by the polarizers via the liquid crystal layer. The transparent substrate is a substrate which is transparent to visible light and is made of, for example, plate glass. On the transparent substrate on the illuminating device 1 side, a TFT (Thin Film Transistor) as a drive element electrically connected to the transparent pixel electrode and an active drive circuit including a wiring are formed. The color filter is constructed by arranging color filters for color-separating light emitted from the illuminating device 1 into, for example, the primary colors of R, G, and B. The transparent electrode is made of, for example, ITO (Indium Tin Oxide) and functions as a common opposed electrode. The alignment film is made of, for example, a polymer material such as polyimide, and performs alignment process on the liquid crystal. The liquid crystal layer is made of, for example, the liquid crystal in the VA (Vertical Alignment) mode, TN (Twisted Nematic) mode, or STN (Super Twisted Nematic) mode and has the function of passing or blocking light from the illuminating device 1 pixel by pixel by an application voltage from the drive circuit. The transparent pixel electrode is made of, for example, ITO and functions as an electrode of each pixel.

Next, the operation in the display device 2 will be described. Light emitted from the point light sources 10 in the illuminating device 1 is adjusted to light having desired front-face luminance, in-plane luminance distribution, view angle, and the like, and the back face of the display panel 20 is irradiated with the adjusted light. The light applied to the back side of the display panel 20 is modulated by the display panel 20 and the resultant light is emitted as image light from the surface of the display panel 20 toward the observer side.

In the display device 2, the expressions (1) to (5) are satisfied in the unevenness canceling sheets 11 and 12 in the illuminating device 1. Consequently, luminance non-uniformity and color unevenness of illumination light applied to the back face of the display panel 20 is reduced. Consequently, the display device 2 having high display quality is provided.

As illustrated in FIG. 25, in the display device 2, in place of the unevenness canceling sheet 12 and the diffusing member 13, an unevenness canceling sheet 18 obtained by integrally forming the unevenness canceling sheet 12 and the diffusing member 13 may be provided on the top face of the unevenness canceling sheet 11.

Although the present invention has been described above by the embodiment, the modifications, and the application example, the invention is not limited to the embodiment and the like but may be variously modified.

For example, in the foregoing embodiment and the like, in the illuminating device 1 and the display device 2, the unevenness canceling sheets 11 and 12, the diffusing member 13, and the prism sheet 14 have been described as the various optical sheets included in the illuminating device 1. As necessary, an optical sheet other than the above may be included in the illuminating device 1 or any of the optical sheets included in the illuminating device 1 may be removed.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An optical sheet stack body comprising two rectangular-shaped optical sheets disposed so as to overlap a plurality of point light sources arranged in a first direction and arranged in a second direction crossing the first direction,
wherein each of the optical sheets is disposed so that a long-side direction of the optical sheet crosses each of the first and second directions at an angle other than right angle,
a first optical sheet as an optical sheet disposed on the point light source side out of the two optical sheets has a plurality of first three-dimensional structures extending in a direction parallel to or almost parallel to the first direction,
a second optical sheet as an optical sheet disposed on the side opposite to the point light source out of the two optical sheets has a plurality of second three-dimensional structures extending in a direction parallel to or almost parallel to the second direction, and
the second three-dimensional structure has a shape by which return light is generated from normal incident light more than the first three-dimensional structure.

2. The optical sheet stack body according to claim 1, wherein an angle formed between the extension direction of the first three-dimensional structures and the first direction is 10 degrees or less, an angle formed between the extension direction of the second three-dimensional structures and the second direction is 10 degrees or less, and an angle formed between the extension direction of the first three-dimensional structure and the extension direction of the second three-dimensional structure lies in a range from 60 degrees to 120 degrees both inclusive.

3. The optical sheet stack body according to claim 1, wherein the first and second three-dimensional structures satisfy the following expressions:
P₃/H>1.3
P₄/H>1.3
20%>Tt1−Tt2>5%
where
P₃ indicates pitch in the first direction of the point light sources,
P₄ indicates pitch in the second direction of the point light sources,
H indicates distance between the point light sources and the first optical sheet,
Tt1 indicates total light transmittance (%) of the first optical sheet when light is allowed to enter normal to the first optical sheet from the point light source side, and
Tt2 indicates total light transmittance (%) of the second optical sheet when light is allowed to enter normal to the second optical sheet from the point light source side.

4. The optical sheet stack body according to claim 1, wherein the first three-dimensional structure has a first top extending in a direction parallel to the first direction, and a pair of first inclined surfaces on both sides of the first top, and
the second three-dimensional structure has a second top extending in a direction parallel to the second direction, and a pair of second inclined surfaces on both sides of the second top.

5. The optical sheet stack body according to claim 4, wherein a surface of each of the first and second tops is a curved surface projected to a light emission side, and
a surface of each of the first and second inclined surfaces is a flat surface.

6. The optical sheet stack body according to claim 5, wherein when an angle formed by a tangent line T₁ which is in contact with the first top and the first inclined surface and a plane T₂ which is parallel to a back face of the optical sheet is set as φ₁ and an angle formed by a tangent line T₃ which is in contact with the second top and the second inclined surface and the plane T₂ is φ₂, φ₁ increases smoothly from the first top toward the first inclined surface, and φ₂ increases smoothly from the second top toward the second inclined surface.

7. The optical sheet stack body according to claim 4, wherein level of the first top is higher than that of the second top.

8. The optical sheet stack body according to claim 1, further comprising a diffuser plate on the second optical sheet.

9. The optical sheet stack body according to claim 8, wherein the first and second three-dimensional structures satisfy the following expressions:
P₃/H>1.3
P₄/H>1.3
0.1≦R₂/P₂<R₁/P₁<0.4
0.02<R₁/P₁−R₂/P₂<0.1
where
P₁ indicates pitch in an arrangement direction of the plurality of first three-dimensional structures,
P₂ indicates pitch in an arrangement direction of the plurality of second three-dimensional structures,
P₃ indicates pitch in the first direction of the point light sources,
P₄ indicates pitch in the second direction of the point light sources,
R₁ indicates curvature of a top of the first three-dimensional structure, and
R₂ indicates curvature of a top of the second three-dimensional structure.

10. The optical sheet stack body according to claim 8, wherein transmittance of the diffuser plate is 60% to 85% both inclusive.

11. The optical sheet stack body according to claim 1, wherein the first or second optical sheet contains a light diffusing material.

12. The optical sheet stack body according to claim 11, wherein an additive amount of the light diffusing material contained in the first or second optical sheet has a value in a range where total light transmittance when light is allowed to enter normal to a transparent plate having a thickness of 2 mm, whose both sides are flat, and to which the same amount of the light diffusing material is added is 81% to 93% both inclusive.

13. The optical sheet stack body according to claim 11, wherein a three-dimensional structure of an optical sheet containing the light diffusing material out of the first and second optical sheets satisfies the following expression:
R/P<0.1
P indicates pitch in the arrangement direction of the plurality of three-dimensional structures, and
R indicates curvature of the top of the three-dimensional structure of the optical sheet.

14. The optical sheet stack body according to claim 8, further comprising a flexible film enveloping the two optical sheets and the diffuser plate.

15. The optical sheet stack body according to claim 8, wherein the two optical sheets are joined to a periphery of the diffuser plate.

16. The optical sheet stack body according to claim 1, wherein the first optical sheet has a thickness of 1 mm or more.

17. The optical sheet stack body according to claim 1, wherein the second optical sheet has a thickness of 1 mm or more, and
the first optical sheet is joined to a periphery of the second optical sheet.

18. The optical sheet stack body according to claim 1, further comprising a transparent supporting member between the plurality of point light sources and the two optical sheets.

19. An illuminating device comprising:
a plurality of point light sources arranged in a first direction and arranged in a second direction crossing the first direction; and
an optical sheet stack body including two rectangular-shaped optical sheets disposed so as to overlap the plurality of point light sources,
wherein each of the optical sheets is disposed so that a long-side direction of the optical sheet crosses each of the first and second directions at an angle other than right angle,
a first optical sheet as an optical sheet disposed on the point light source side out of the two optical sheets has a plurality of first three-dimensional structures extending in a direction parallel to or almost parallel to the first direction,
a second optical sheet as an optical sheet disposed on the side opposite to the point light source out of the two optical sheets has a plurality of second three-dimensional structures extending in a direction parallel to or almost parallel to the second direction, and
the second three-dimensional structure has a shape by which return light is generated from normal incident light more than the first three-dimensional structure.

20. A display device comprising:
a display panel which is driven on the basis of an image signal; and
an illuminating device which illuminates the display panel,
wherein the illuminating device includes:
a plurality of point light sources arranged in a first direction and arranged in a second direction crossing the first direction; and
an optical sheet stack body including two rectangular-shaped optical sheets disposed so as to overlap the plurality of point light sources,
each of the optical sheets is disposed so that a long-side direction of the optical sheet crosses each of the first and second directions at an angle other than right angle,
a first optical sheet as an optical sheet disposed on the point light source side out of the two optical sheets has a plurality of first three-dimensional structures extending in a direction parallel to or almost parallel to the first direction,
a second optical sheet as an optical sheet disposed on the side opposite to the point light source out of the two optical sheets has a plurality of second three-dimensional structures extending in a direction parallel to or almost parallel to the second direction, and
the second three-dimensional structure has a shape by which return light is generated from normal incident light more than the first three-dimensional structure.
